(19) United States
(12) Patent Application Publication
(10) Pub. No.: US 2006/0271971 A1
(43) Pub. Date: Nov. 30, 2006

(54) Interactive television system

(76) Inventor: Jonathan Peter Vincent Drazin, South Oxfordshire (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/560,631

(22) PCT Filed: Jun. 14, 2004
(86) PCT No.: PCT/GB04/02568

§ 371 Date: Dec. 13, 2005

(30) Foreign Application Priority Data
Jun. 13, 2003 (GB) 0313720.5

(51) Int. Cl. H04N 5/44; H04N 7/173

(52) U.S. Cl. 725/86; 725/100; 725/131; 348/725

(57) ABSTRACT

A television system for presenting interactive television services to a user. The system comprises a local memory in which one or more data parameters are stored. The system is operable to determine the availability of data from a data source, and capture a first portion of the available data and store it in a first area of the local memory. The system uses the parameters stored in the local memory to determine whether the first data portion references a second portion of the available data. In the event that it does, the second portion of the data is captured and also stored in the first area of local memory. The first and second portions of data are processed according to their identities. The processed data is written to a second area of the local memory, so that it can be used to present interactive television services to the user.

The present invention relates to an interactive television system that is operable to download a conditional hierarchy of data objects into electronic memory within a television, set-top-box or some other consumer electronic appliance that receives and displays a television service.

### BACKGROUND OF THE INVENTION

Interactive services to digital television and set-top-box platforms have been in operation for a number of years. These generally allocate volatile memory (i.e. where memory contents are lost when power is withdrawn), usually dynamic random access memory (DRAM), within the platform to temporary storage of an interactive software application. Users may invoke the application by responding to a cue displayed on the platform's screen, causing the platform to download the application to the storage area from a continuously broadcast “carousel” of data. Normally the application is split into multiple objects, some comprising program executables, with others comprising data objects including graphics, video, text and sound objects. Each object may link to other objects. Normally, the application persists in storage until the user selects another application cue, whereupon it is either wholly or partially overwritten by the new application so, that if the user selects it again, the application must be again downloaded. Often, the application's objects are broadcast alongside a television service so that they share the same multiplex. In which case, the cue is often displayed over the television video in a format or style specific to the application.

There are a number of problems associated with this approach. First, the user experiences an undesired delay between selecting the cue and the application starting up while the application's objects are downloaded into the platform. Second, the broadcaster must repetitively broadcast the same application, usually many hundreds or thousands of times during the day. This is wasteful of bandwidth, and is particularly costly to terrestrial broadcasters whose available bandwidth is often limited compared to their cable and satellite counterparts.

An alternative approach is to store the application in the platform in non-volatile memory (often referred to as “flash memory”) as “firmware” during manufacture. This has the advantage that the application is pre-stored within the platform, and hence more responsive, but a disadvantage is that many types of interactive application become out of date almost immediately or during the platform's service life. An alternative is to download to the platform's flash memory new versions of the application, or different applications, throughout the platform's service life. However, there are drawbacks with this approach also. First, non-volatile flash memory is more expensive, size for size, when compared to volatile DRAM—making flash firmware implementations generally more expensive compared to DRAM based memory. Second, data written to and recovered from storage using the cheaper (so called “NAND”) forms of flash memory are occasionally corrupted and unreliable, and must be read serially into DRAM for error detection/correction first before they can be executed or processed—with a result that large amounts of DRAM are required in any case to host the application's code and data during execution.

Another trend in provision of interactive television services is to broadcast only a single interactive application object which is downloaded into all types of platform, irrespective of their storage capacity, brand or model identity, or other platform parameters such as type of central processor unit (CPU) or platform location. Most such applications are broadcast in so called “middleware” formats that are independent of a platform's hardware or CPU type, such as MHEG-5, JavaTV, MHP (Multimedia Home Platform), MediaHighway or OpenTV, and interpreted locally. Generally, there is limited interoperability between these middleware formats so that, for example, a platform configured or “ported” to play OpenTV applications cannot simultaneously play, say, a MediaHighway application. The growing number of incompatible middleware formats has introduced uncertainties and risks for manufacturers, pay-television operators and broadcasters. In particular, they face the risk of investing in middleware formats that later become obsolete or overtaken as a viable medium by other, rival formats.

Another trend in provision of interactive services is to broadcast interactive applications within the same transport streams as conventional television services in order to enhance them. For example, a recipe application may be broadcast during a cookery programme and trigger appearance of a cue to invite users to interact with the application at certain points during the programme. Another example is an interactive “infomercial” application that may contain information or background to a conventional television advertisement being viewed simultaneously on screen. A fundamental limitation of these current methods is that the applications are downloaded either in real-time during or seconds in advance of the broadcasts of the television programmes or advertisements they are supposed to accompany. This can result in delays to their usability while they are downloaded to platforms and, where applications are repetitively rebroadcast during programmes, wasted bandwidth also.

Another trend in provision of interactive services is to introduce digital television receiver platforms that are capable also of receiving broadband internet services and displaying combinations of both types of services to the user. A limitation of such current platforms is the need for users to manually request firmware updates for these platforms, especially when they are connected to external devices such as local area network (LAN) adapters for which additional driver firmware is needed.

There is a growing trend for competition among both manufacturers and retailers in the set-top-box market and television receiving platforms in general. As a consequence manufacturers seek a process whereby they can offer features on their products within broadcast services that can be differentiated from competing manufacturers. Similarly, retailers seek a process whereby they can imprint their identity on the products they sell in order to maintain their customer awareness and to promote new products.

### SUMMARY OF THE INVENTION

Various aspects of the invention are defined in the accompanying independent claims. Some preferred features are defined in the dependent claims.

According to one aspect of the invention, there is provided a television platform for presenting interactive television services to a user, the platform comprising a local memory; means for determining availability of data from a remote data source; means for capturing a first portion of the available data and storing it in a first area of the local memory, said first portion having a specified identity; means for determining whether the first data portion references a second portion of the available data depending on a value of one or more parameters stored in the local memory, the second portion also having a specified identity; means for capturing the second portion and storing it in the first area of local memory in the event that a reference between the first and second portions is found; means for processing the first and second portions of data according to their identities and writing the processed data to a second area of the local memory, and means for using the processed data to present interactive television services to the user.

By periodically downloading data, such as system software, from a broadcast or uploading it from a source across the internet and processing and storing it locally, increased flexibility can be achieved. Further benefits can be achieved because middleware and application objects can be conditionally downloaded according to the values of parameters stored within each platform. This allows the appearance and functional behaviour of each platform to be customised according to its brand, model number or platform type, and/or personalised according to its users' preferences or histories of use. Hence, a manufacturer or retailer may differentiate the appearance of services carried on its platforms from those of its competitors. Further, a service operator can target downloading of driver software for peripherals (e.g. a LAN card) to certain STBs after they are sold. Further savings to broadcasters can be achieved if multiple instances of a broadcast interactive television service, each targeted to different permutations of platforms, can be broadcast during a single download session where objects that are common to a plurality of platforms are broadcast only once during a session.

In one embodiment, the first and second memory areas are volatile memory, such as DRAM. By using DRAM instead of more costly flash memory as the second memory area for storing the interactive software, costs savings can be obtained for platform manufacturers and users, because the overall memory cost of the platform is reduced. A further advantage is that operational flexibility may be achieved for television network operators and broadcasters because a type or revision of middleware can be replaced immediately during a single download to DRAM.

Another advantage is that the system of the invention locates and binds driver and software updates to itself automatically according to its identity and according to the identities of external devices to which it is connected, thus eliminating the inconvenience to users of having to manually configure or initiate update of the system with new software. This is especially usefully for digital broadcast television receiver platforms that are required later to connect to the internet, but to which no communications adapter was included at the point of sale. According to the invention, a user may later add a communication interface to the platform, whose presence is recognised by the platform using any suitable means. Once this interface is added the platform is caused to download those software drivers and applications over the air necessary for its proper functioning.

Interactive applications may be downloaded to DRAM days or hours in advance of television programmes or advertisements to cause interactive enhancements to later appear in conjunction with said programmes and advertisements with bandwidth savings to broadcasters and improved responsiveness to users, television programme makers and advertisers.

The ability of a retailer to sell a pre-paid service to a platform user is beneficial because of the greater sales value to the retailer. Prepayment may be effected by sale in retail of numbered coupons. The user scratches the coupon surface to reveal a number which is quoted to the service operator which, in turn, addresses a broadcast entitlement message to the user's platform. It is further recognised that the method is of value to users because it does not restrict them otherwise to pay for services by credit card over the telephone or via other electronic means. Moreover, a process whereby a retailer continues to maintain a promotional reach into platforms it has sold is useful to maintain users' awareness and to inform users of new items for sale by the retailer.

Bandwidth savings to broadcasters can be achieved if certain popular applications and middleware components are broadcast once or a small number of times during a day. Each time these are broadcast, preferably the platform is operable to identify whether any available data is different from that already stored in the local memory. Preferably, this can be done whilst the platform is set by the user to stand-by mode. In the event that the data is different, the platform is operable to power up and capture it. In the event that the data is not different, the platform is operable to remain in stand-by mode. In this way, energy savings can be obtained with consequent economic benefits to users and the environment.

According to another aspect of the invention, there is provided a television system comprising means for broadcasting television content and additionally data streams that include data and/or software up-dates; and a plurality of different user platforms for receiving the television content and the data streams, wherein the data streams include a plurality of different user platform identifiers for identifying which parts of the stream are for use by which platforms, at least some of the data and/or software being sharable by more than one of the platforms, and each user platform is operable to recognise the parts of the data stream that are for use by it and use those parts to cause content or images to be presented on screen simultaneous with or as an alternative to the television content.

By structuring the data streams so that at least some of the data and/or applications can be shared by different types of platforms, it is possible to send up-dates to a large number of different user platforms at relatively low bandwidths.

### Various aspects of the invention will now be described by way of example only and with reference to the accompanying drawings, of which:

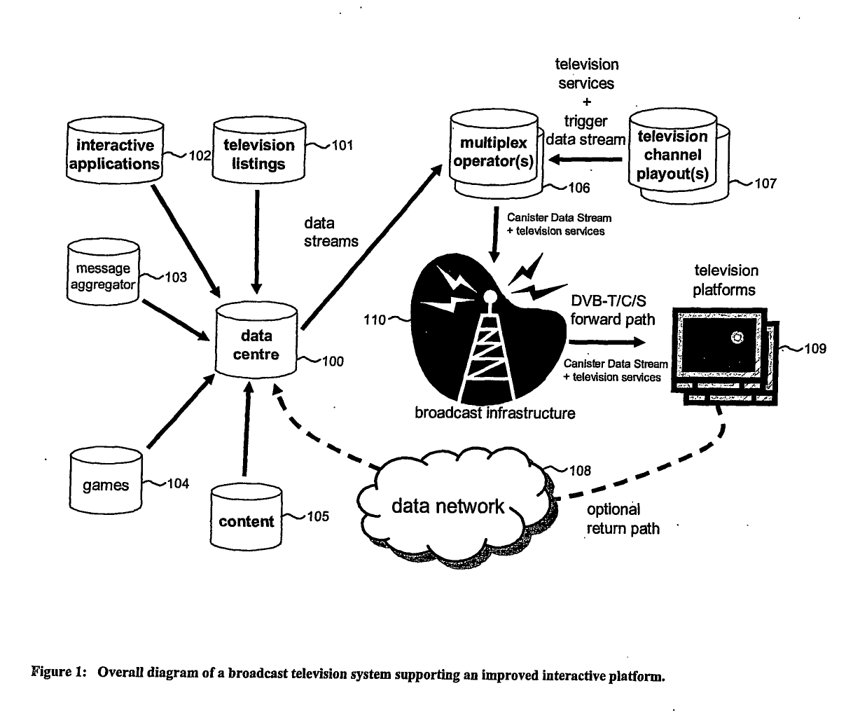

FIG. 1 is a block diagram of a television broadcast system;

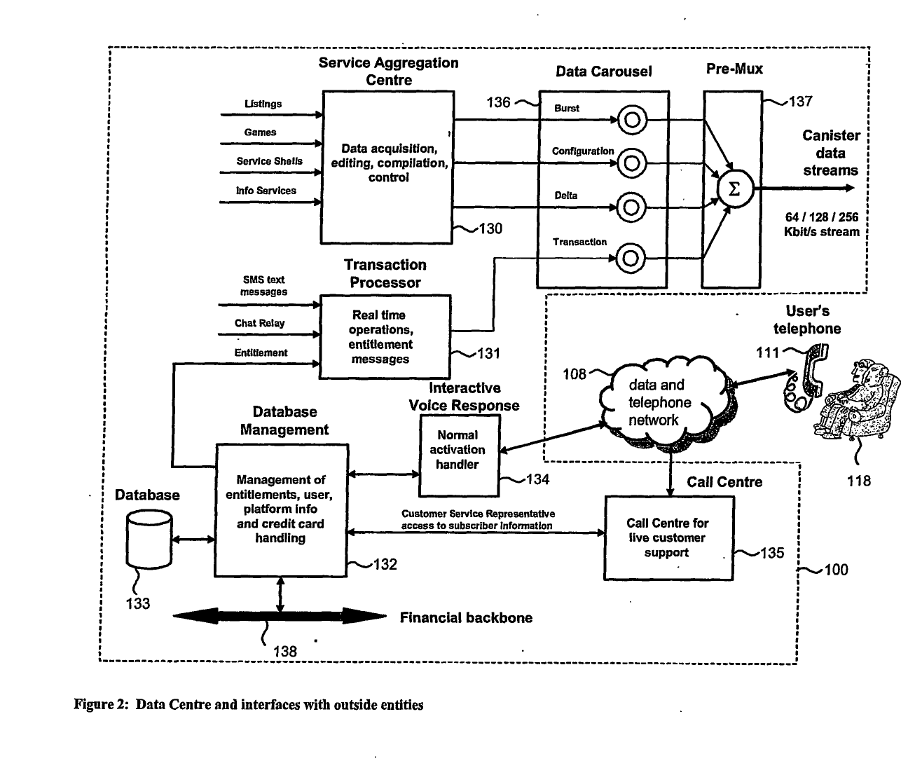

FIG. 2 is a block diagram of a data centre of the system of FIG. 1;

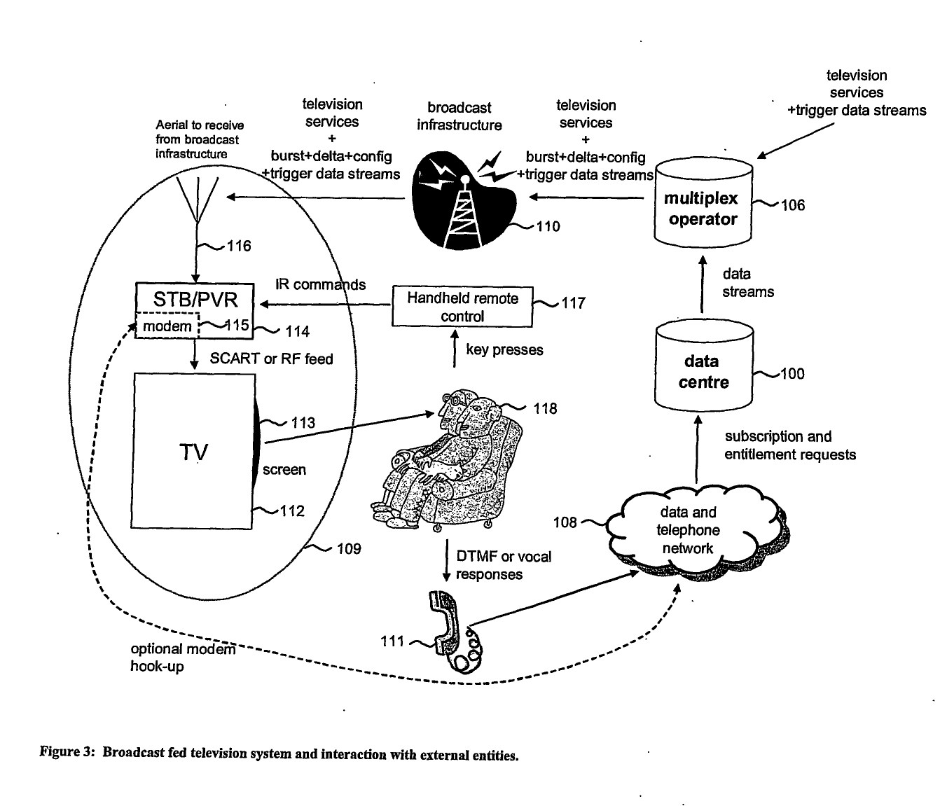

FIG. 3 is a block diagram of a television system that is configured to allow interaction with external entities;

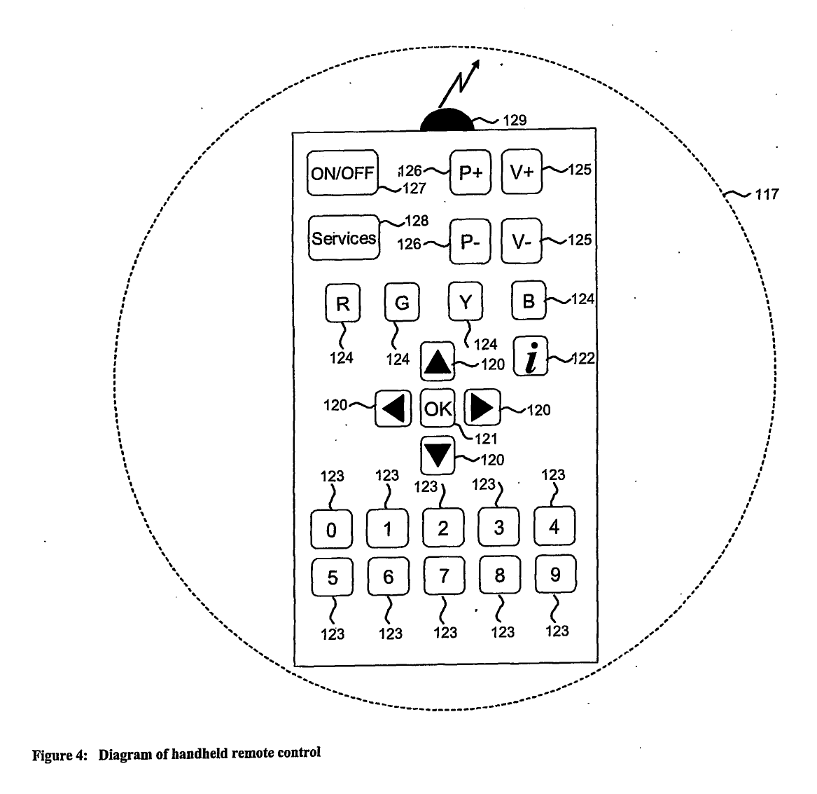

FIG. 4 is a top view of a remote control unit for use in the system of FIG. 1;

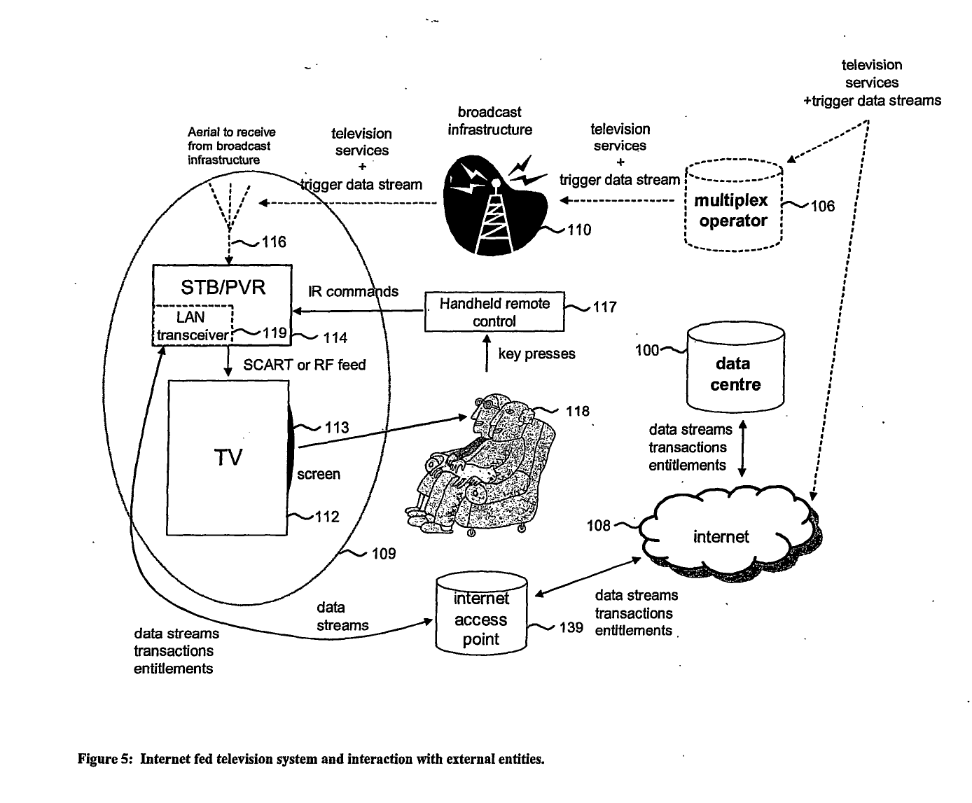

FIG. 5 is a block diagram of another television system that is configured to allow interaction with external entities;

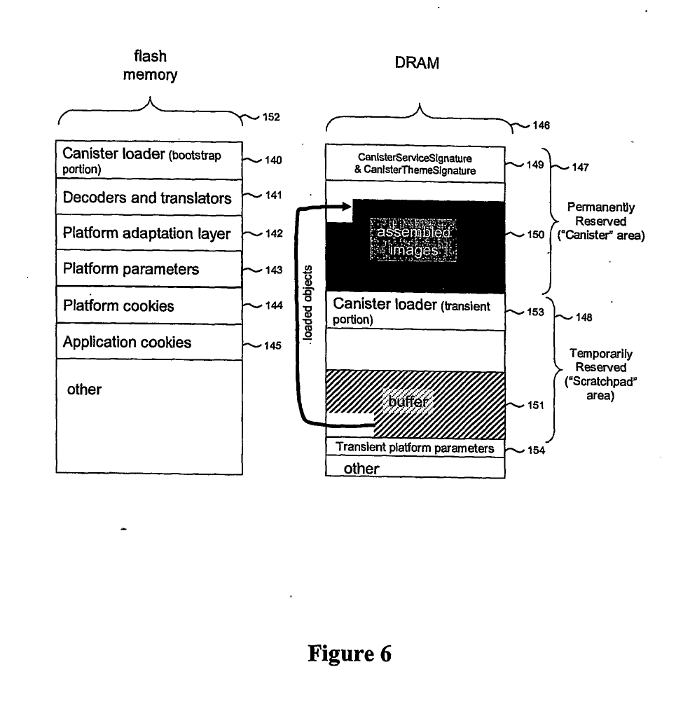

FIG. 6 is an illustration of how memory is allocated in a user platform, such as the television, of the system of FIG. 1;

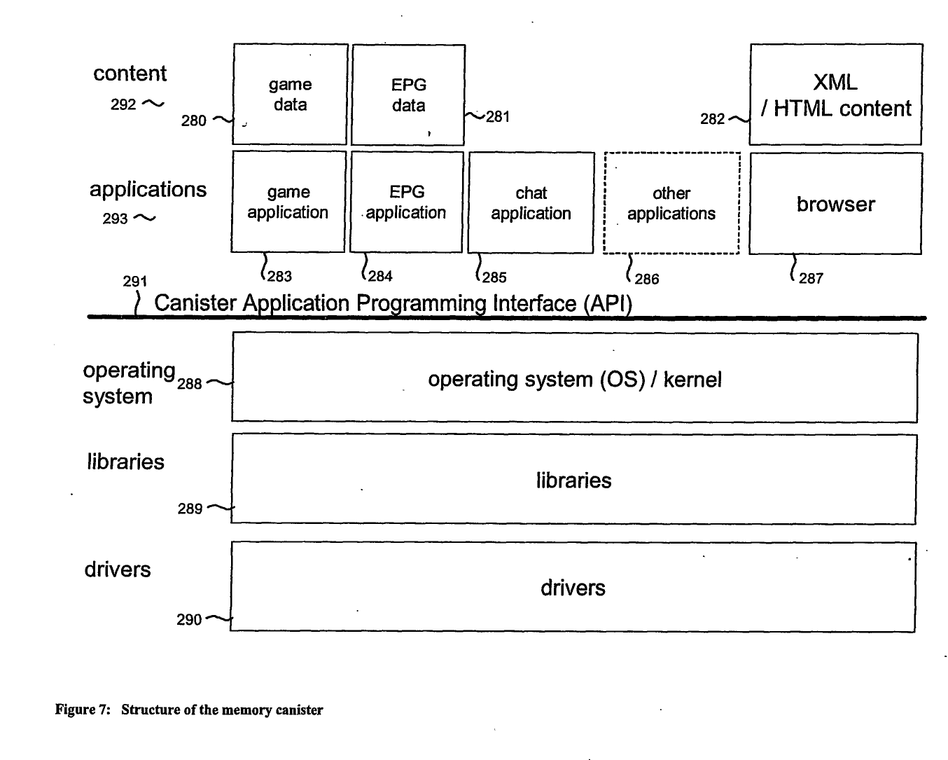

FIG. 7 is an illustration of the structure of a canister that is included in the memory resources shown in FIG. 6;

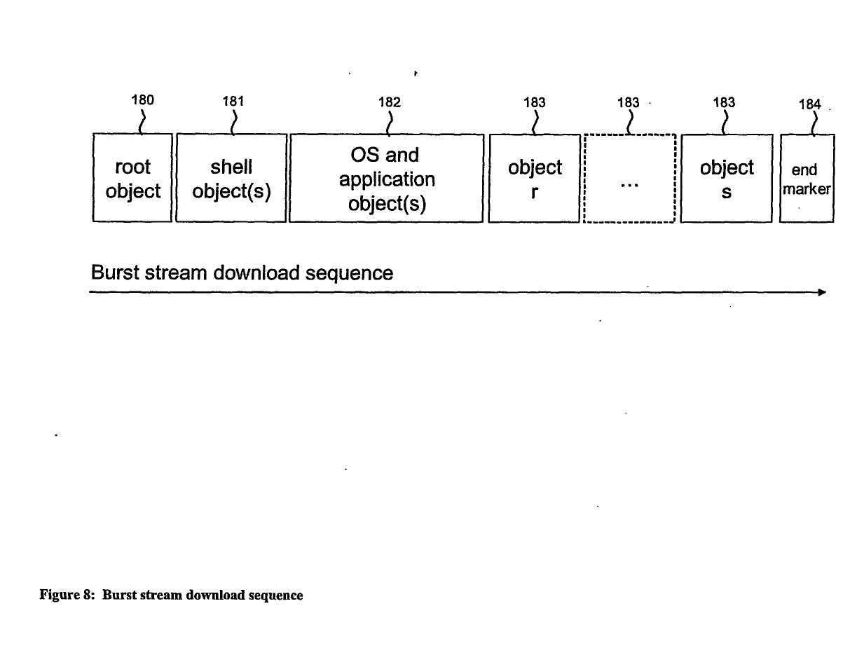

FIG. 8 shows a burst stream sequence;

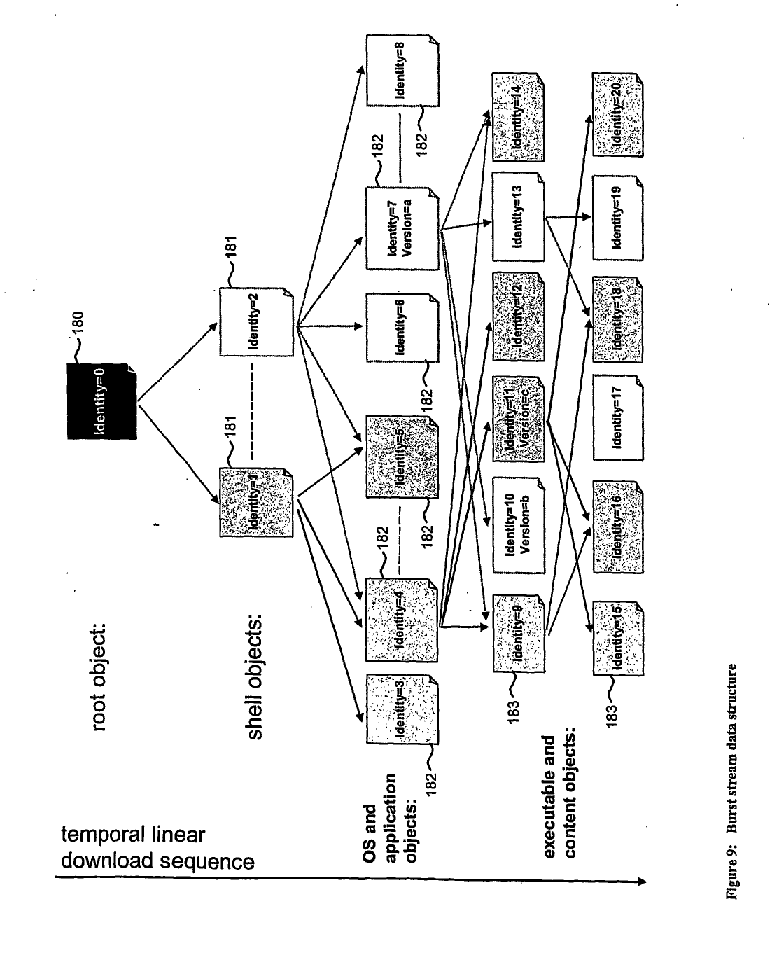

FIG. 9 is an illustration of a burst stream data structure;

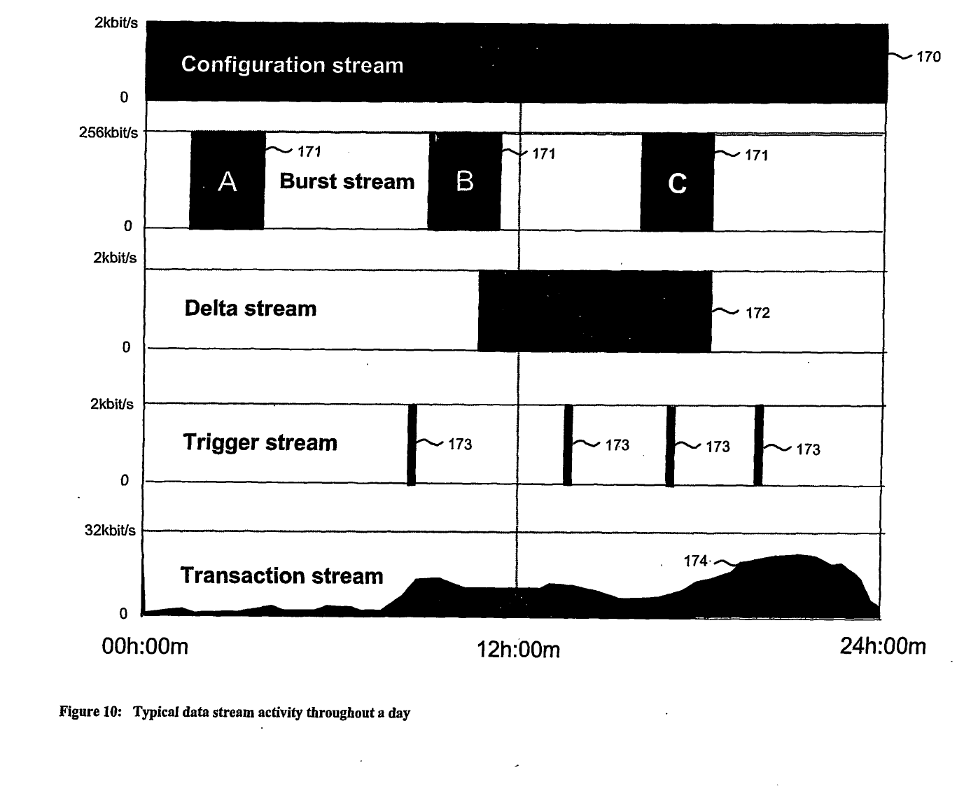

FIG. 10 is a temporal view of typical data stream activity throughout a day;

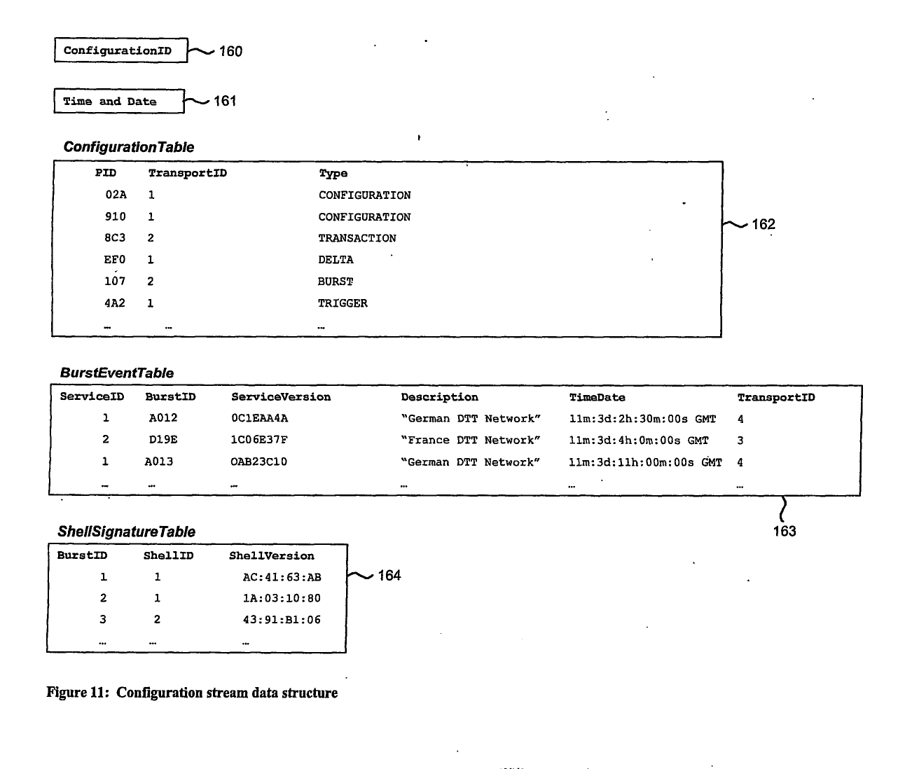

FIG. 11 shows various tables that are included in the burst streams;

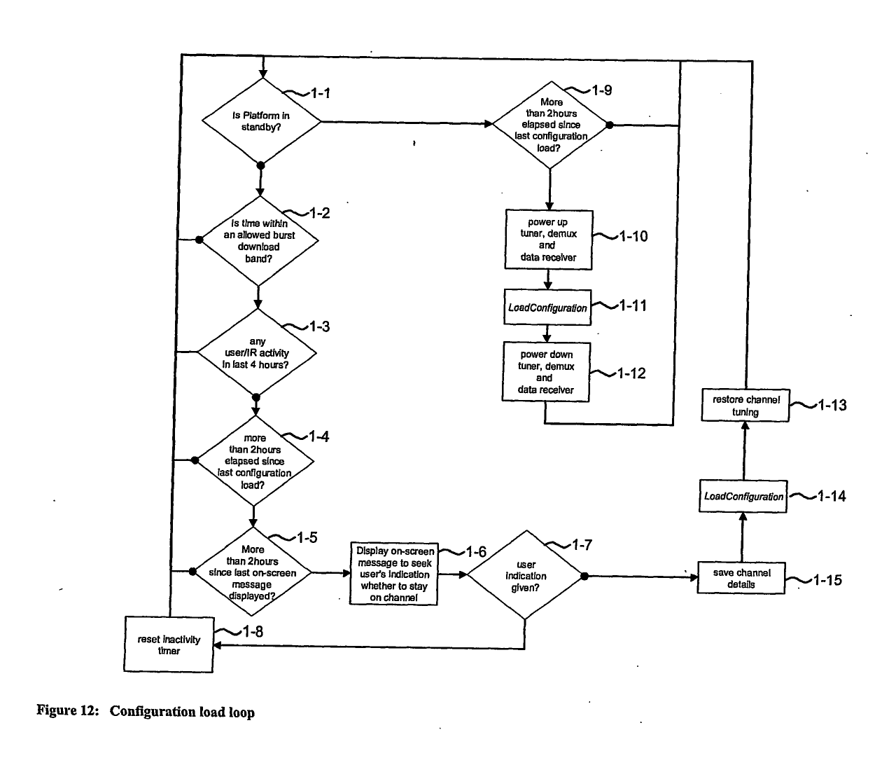

FIG. 12 is a flow diagram of the configuration load loop;

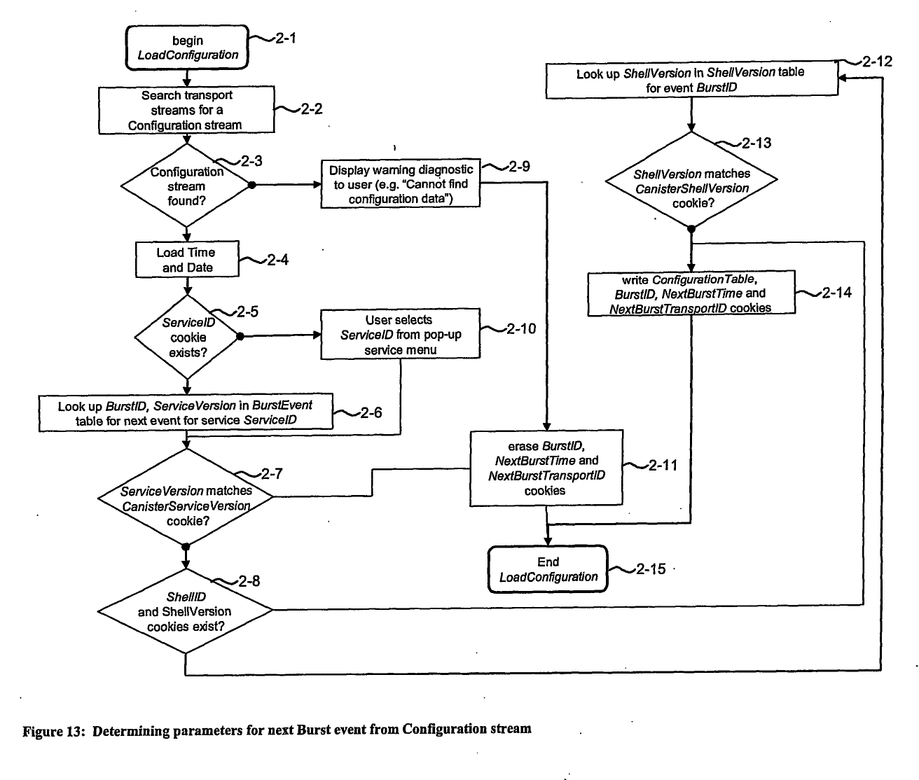

FIG. 13 is a flow diagram of a process for determining parameters for next burst events from an incoming configuration stream;

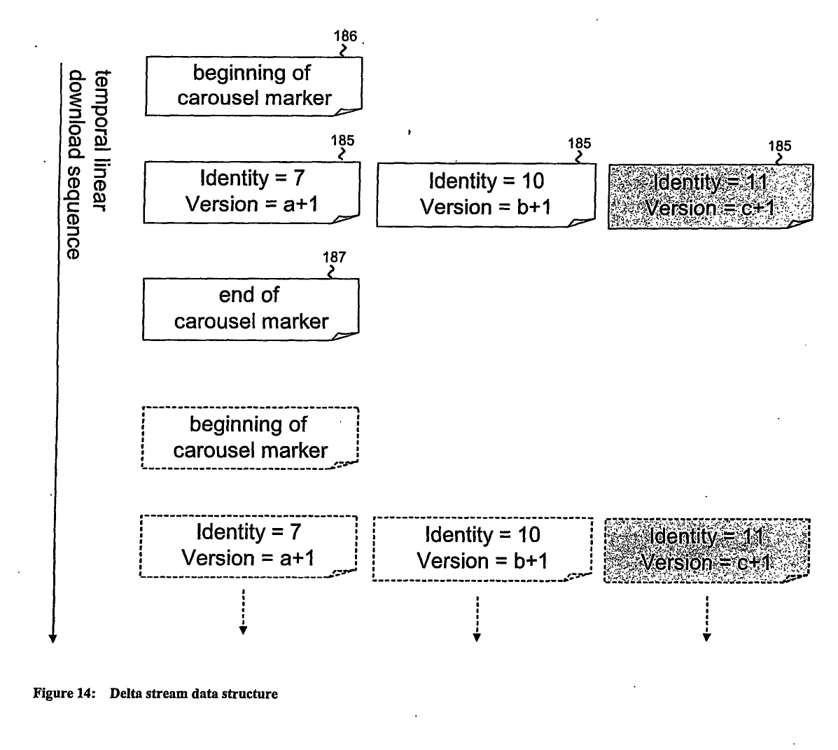

FIG. 14 is an illustration of a delta stream data structure;

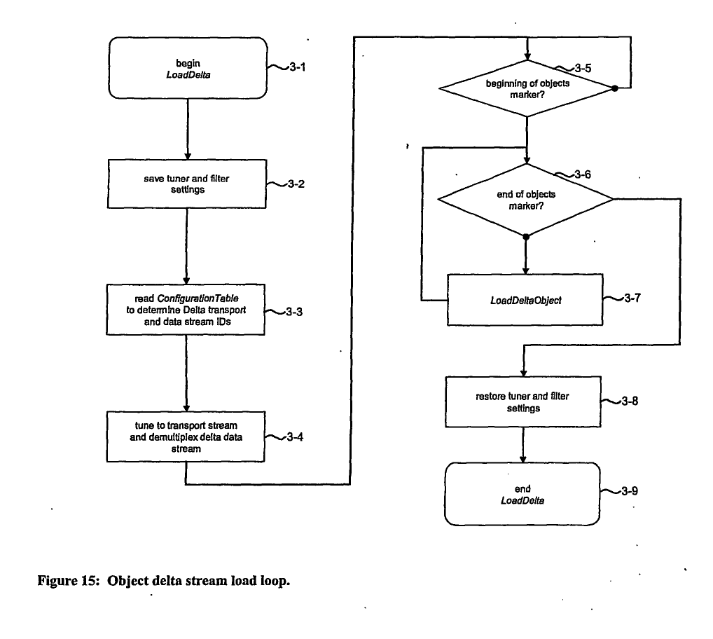

FIG. 15 is a flow diagram of an object delta stream load loop;

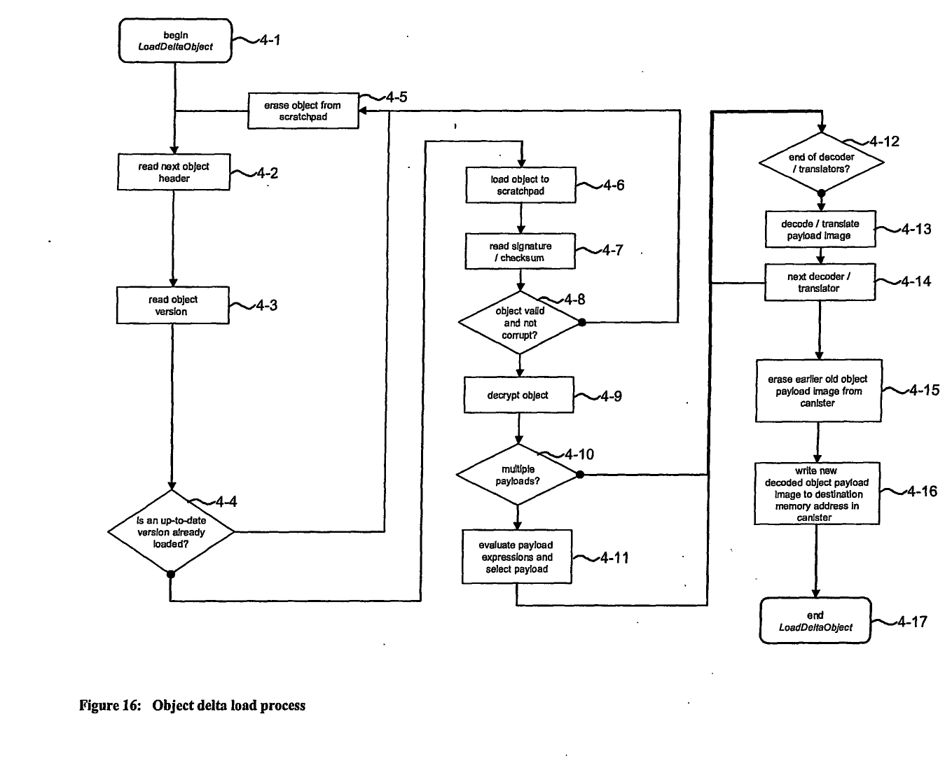

FIG. 16 is a flow diagram of an object delta load process;

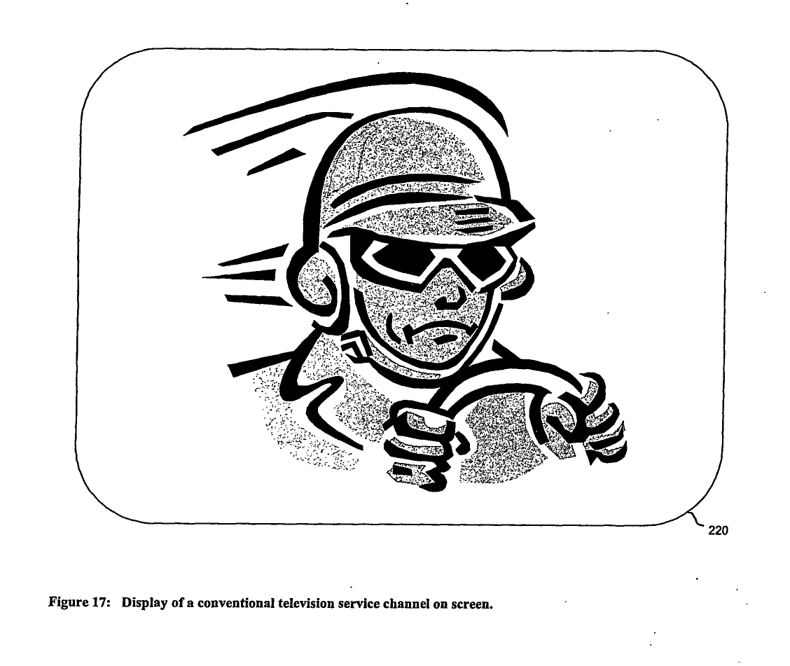

FIG. 17 is a view of a screen shot of a conventional television service channel;

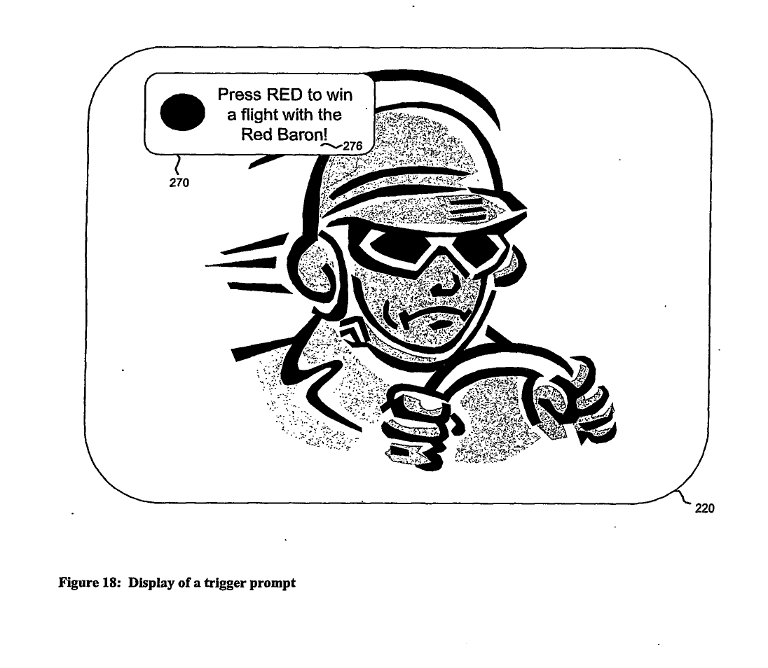

FIG. 18 shows the screen shot of FIG. 17 in which a trigger prompt is presented;

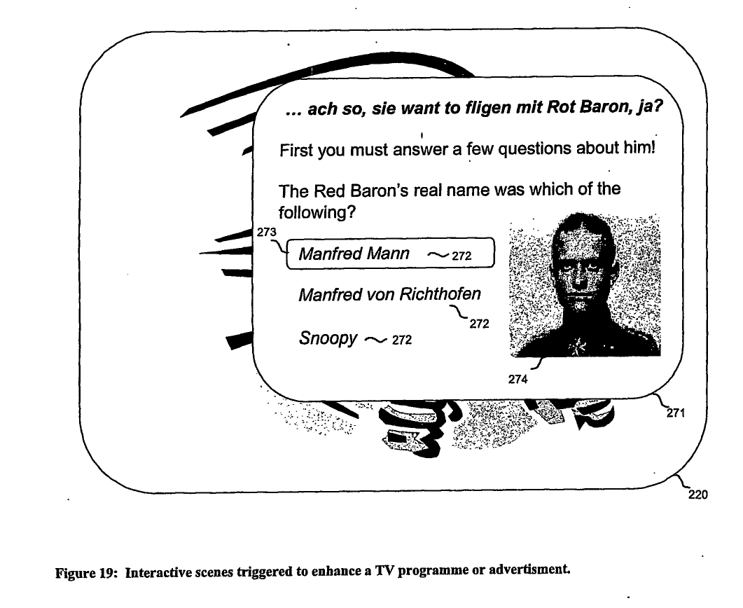

FIG. 19 shows the screen shot of FIG. 17 in which interactive scenes are triggered to enhance a television programme or advertisement;

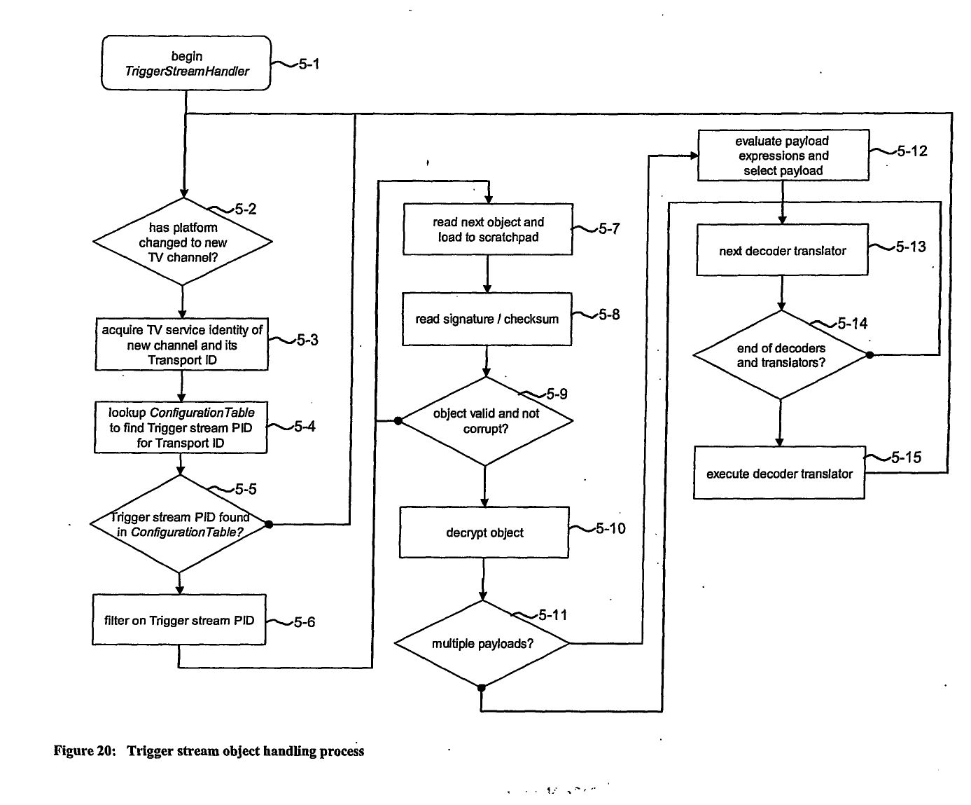

FIG. 20 is a flow diagram of a trigger stream object handling process;

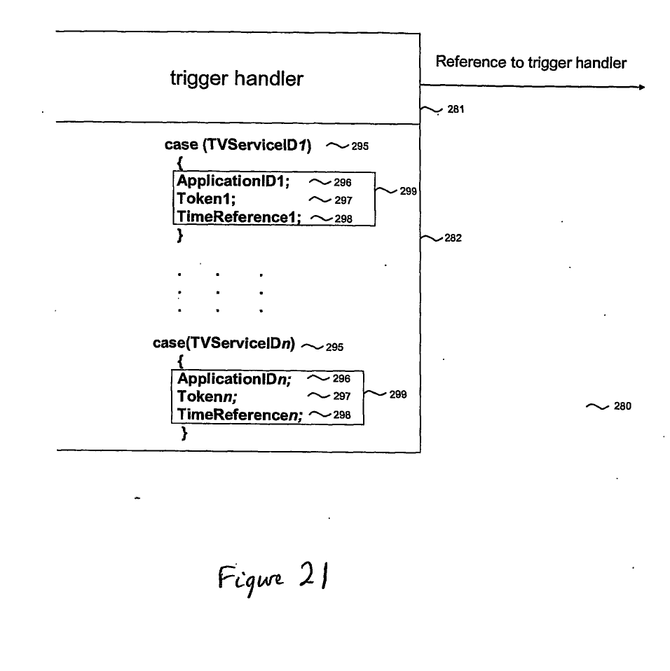

FIG. 21 is a diagrammatic representation of a trigger payload structure;

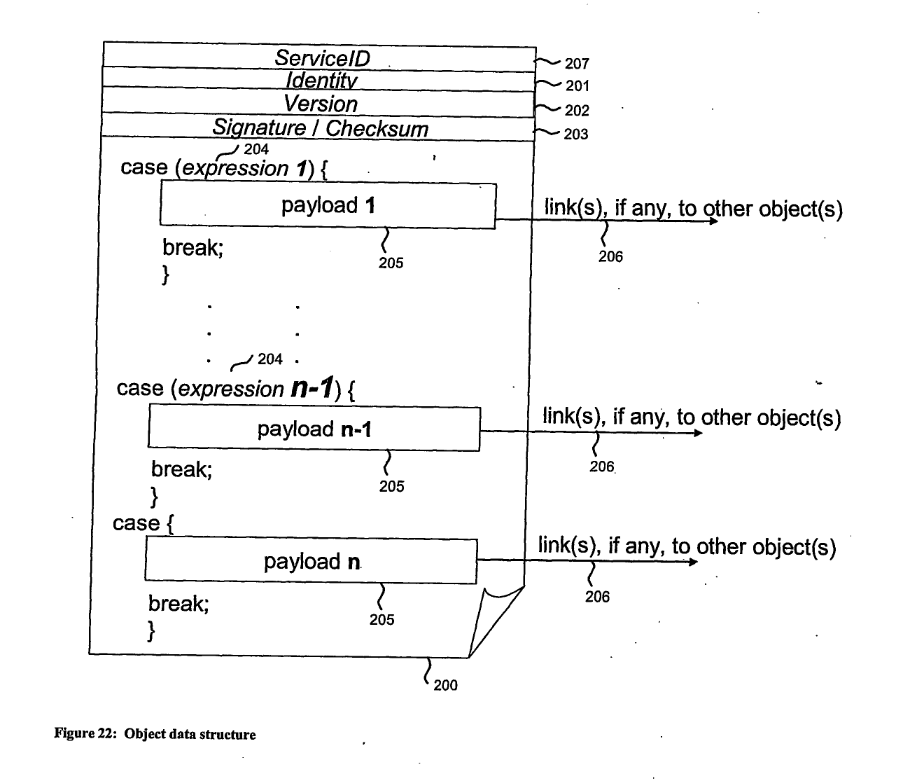

FIG. 22 is a diagrammatic representation of an object data structure;

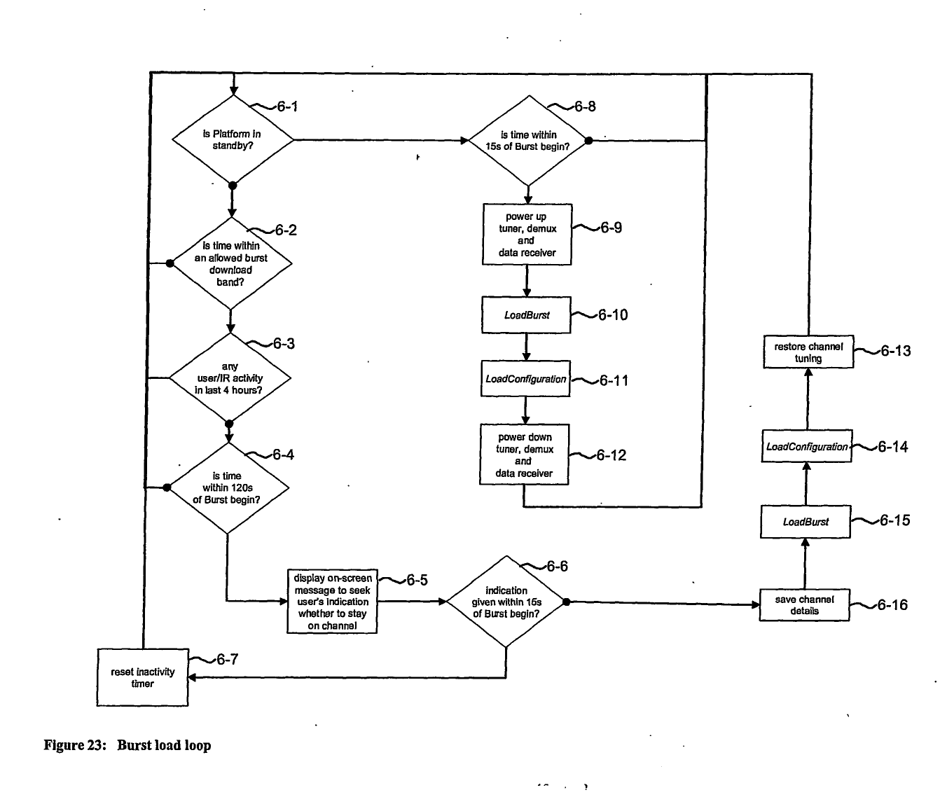

FIG. 23 is a flow diagram of a burst load loop;

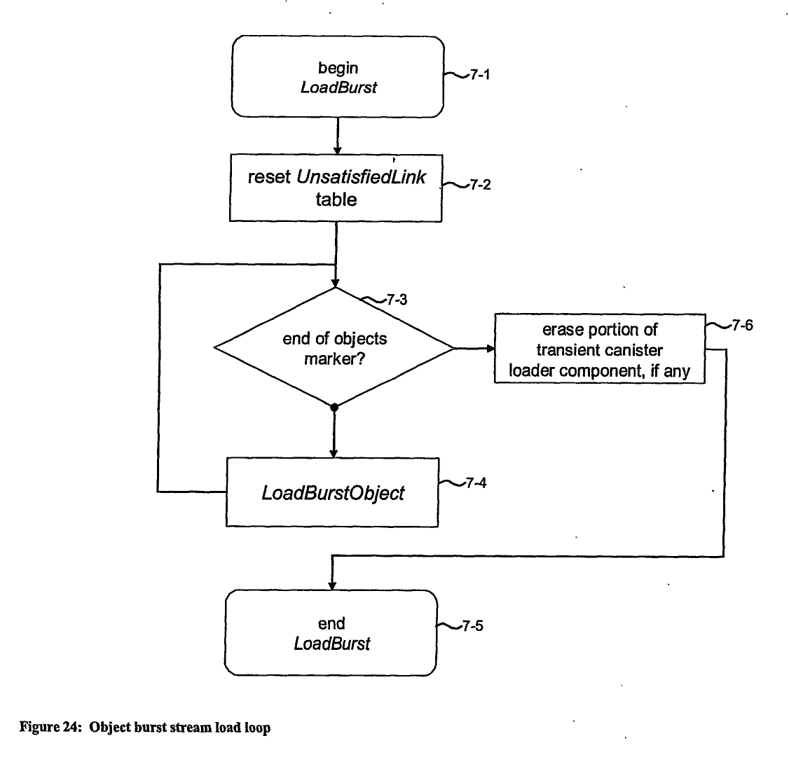

FIG. 24 is a flow diagram of an object burst stream load loop;

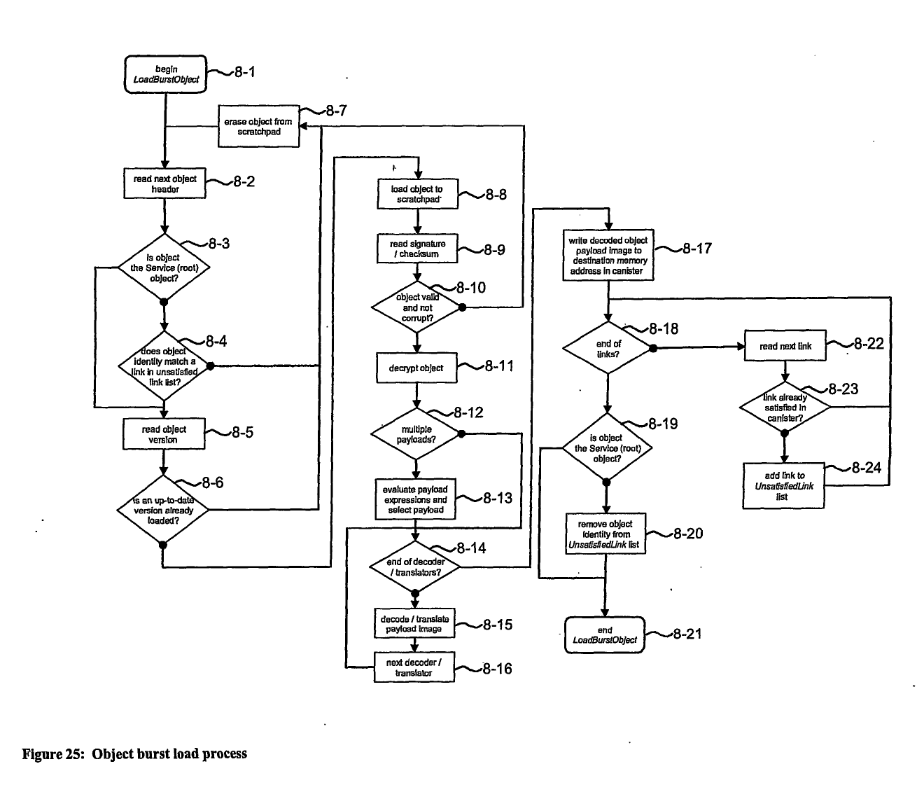

FIG. 25 is a flow diagram of an object burst load process;

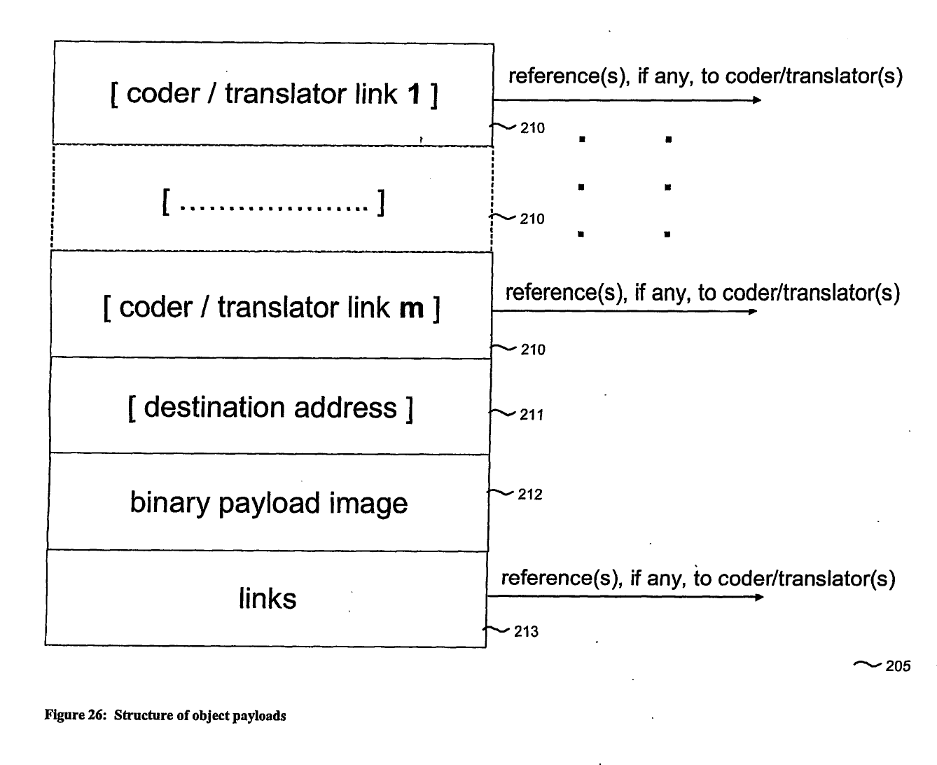

FIG. 26 is a diagrammatic representation of the structure of an object payload;

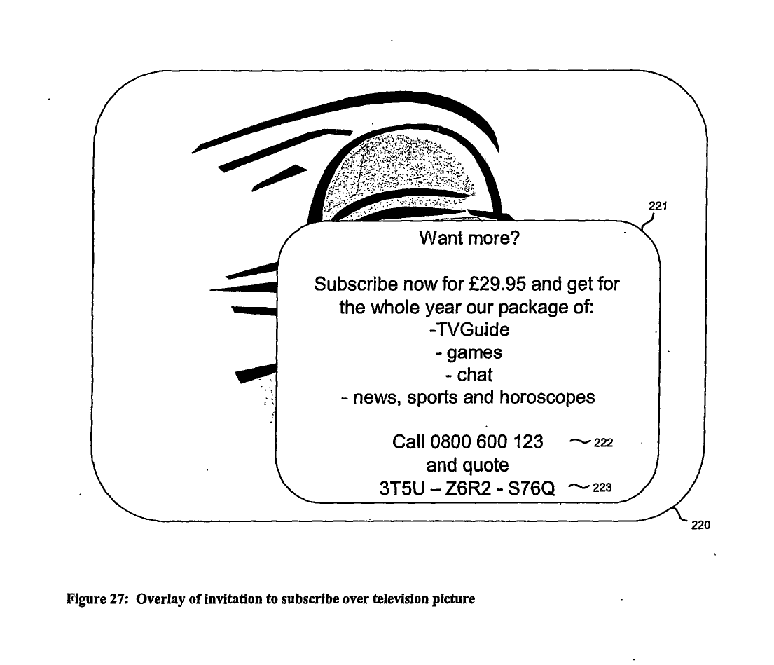

FIG. 27 is a screen shot of a television display over which an overlay of an invitation to subscribe is presented;

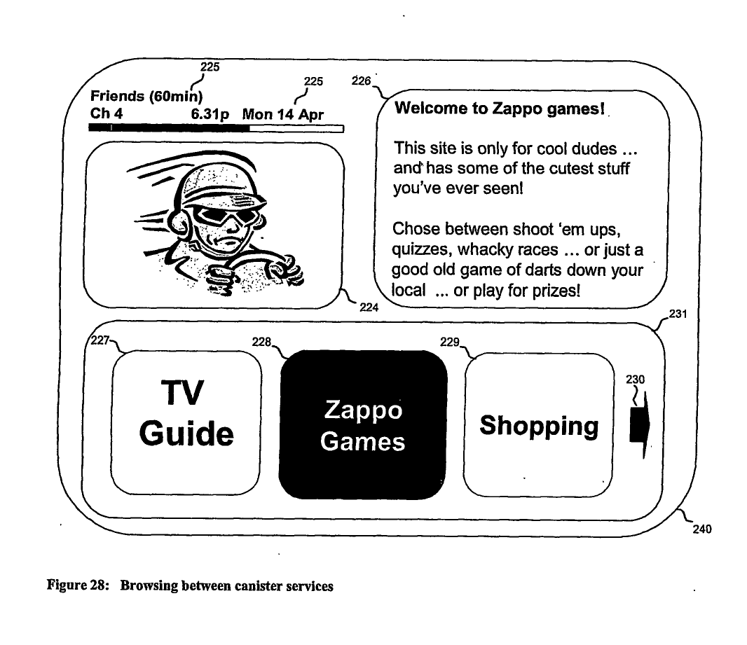

FIG. 28 is a screen shot of a television display on which interactive and user selectable icons representing various services are presented;

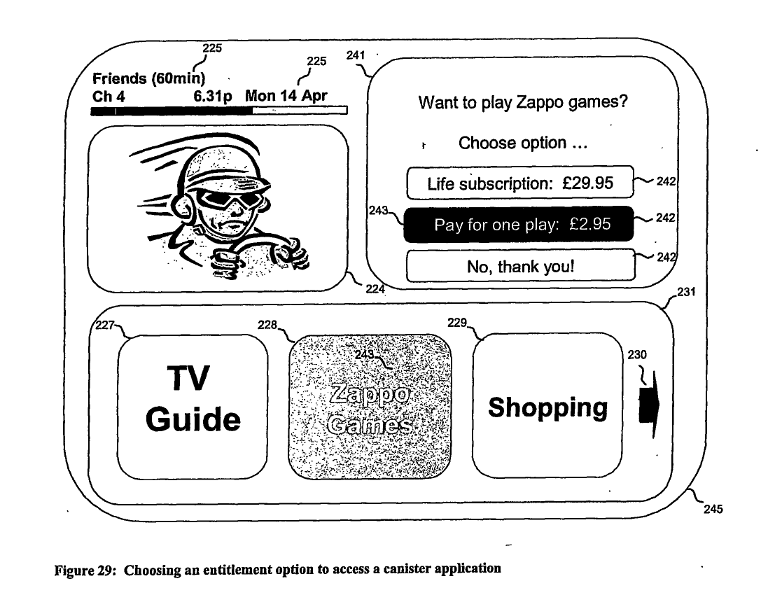

FIG. 29 is a screen shot similar to that of FIG. 28, except that in this case one of the services is selected and a list of entitlement options is presented;

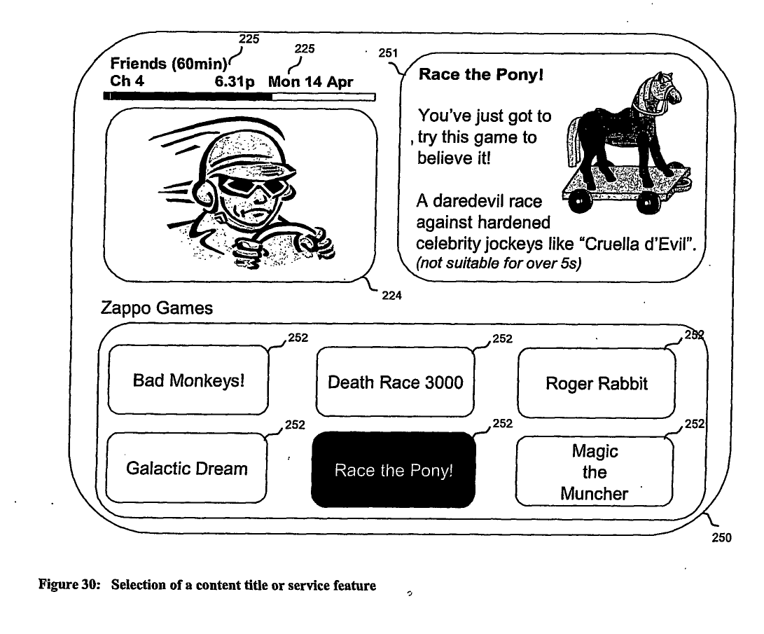

FIG. 30 is a screen shot of a television display on which interactive and user selectable content title or service features are presented;

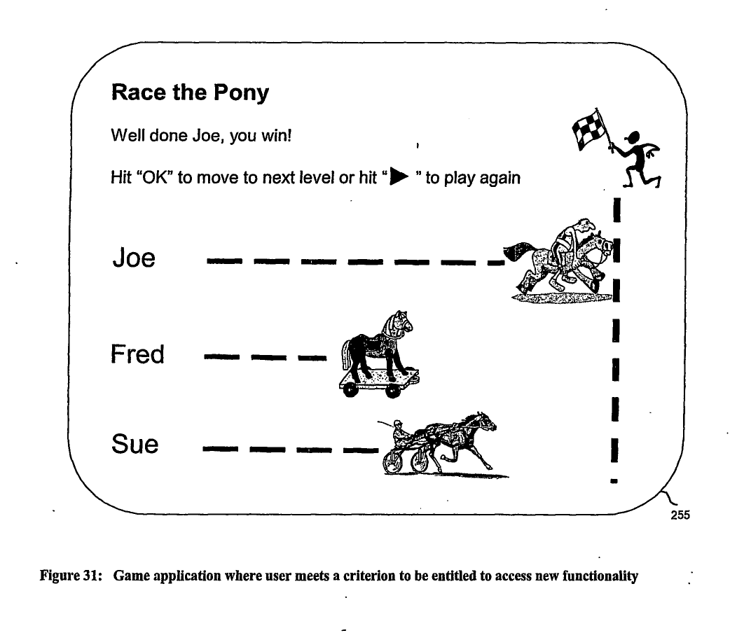

FIG. 31 is a screen shot of a game application in which a criterion has to be met to allow access to new functionality;

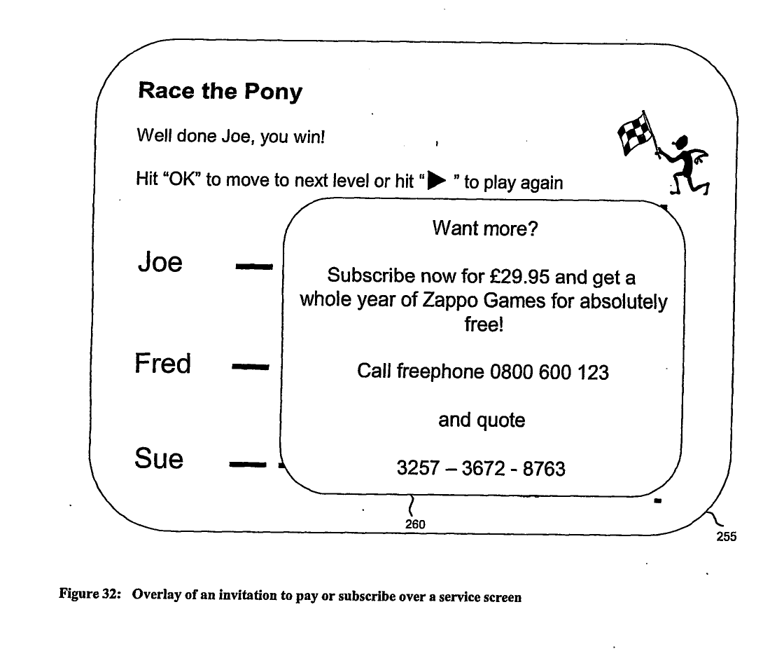

FIG. 32 is a screen shot of the game of FIG. 31, in which an overlay is presented;

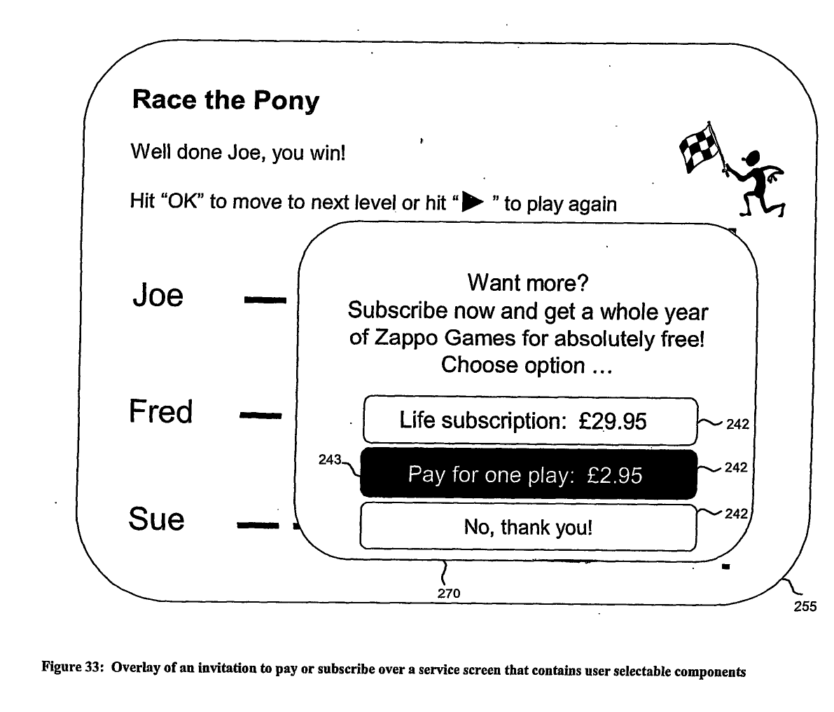

FIG. 33 is a screen shot similar to that of FIG. 32, except that in this case a list of user selectable entitlement options is presented;

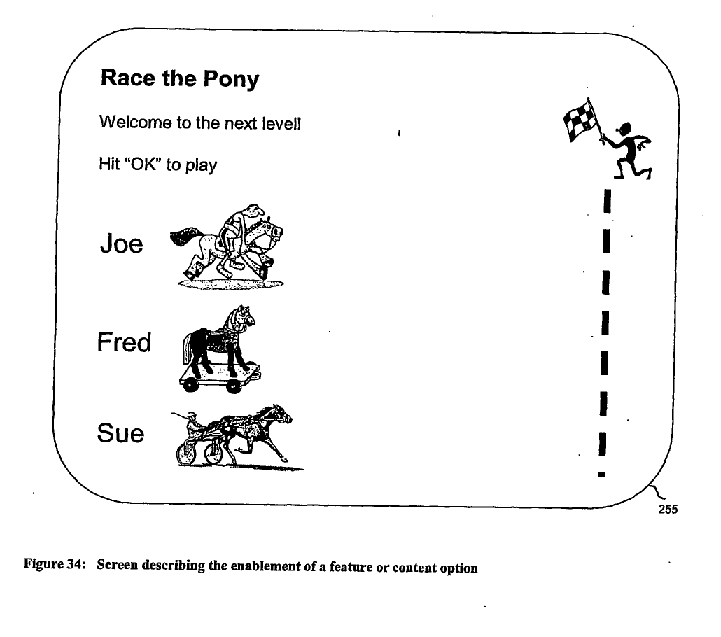

FIG. 34 is a screen shot showing the enablement of a feature or content option;

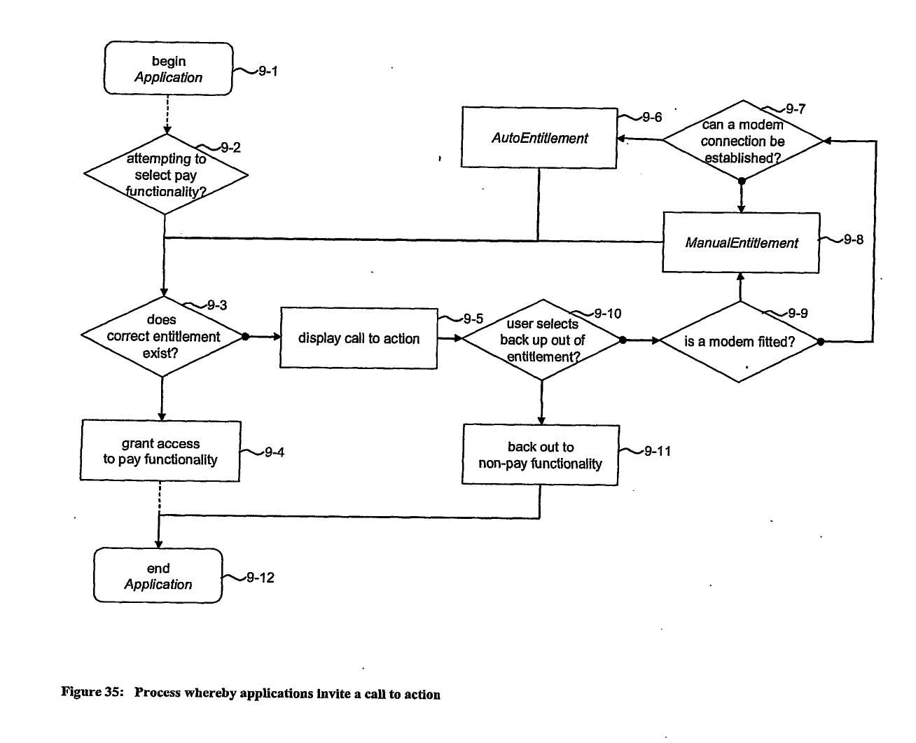

FIG. 35 is a flow diagram of a process whereby applications invite a call to action;

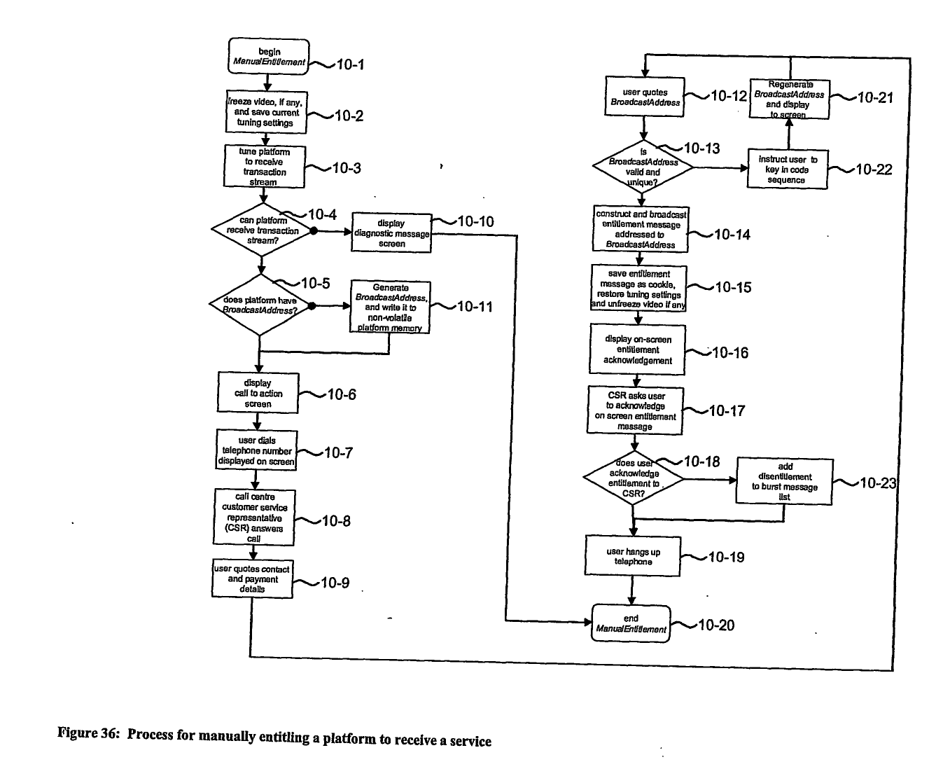

FIG. 36 is a flow diagram showing a process for manually entitling a platform to receive a service;

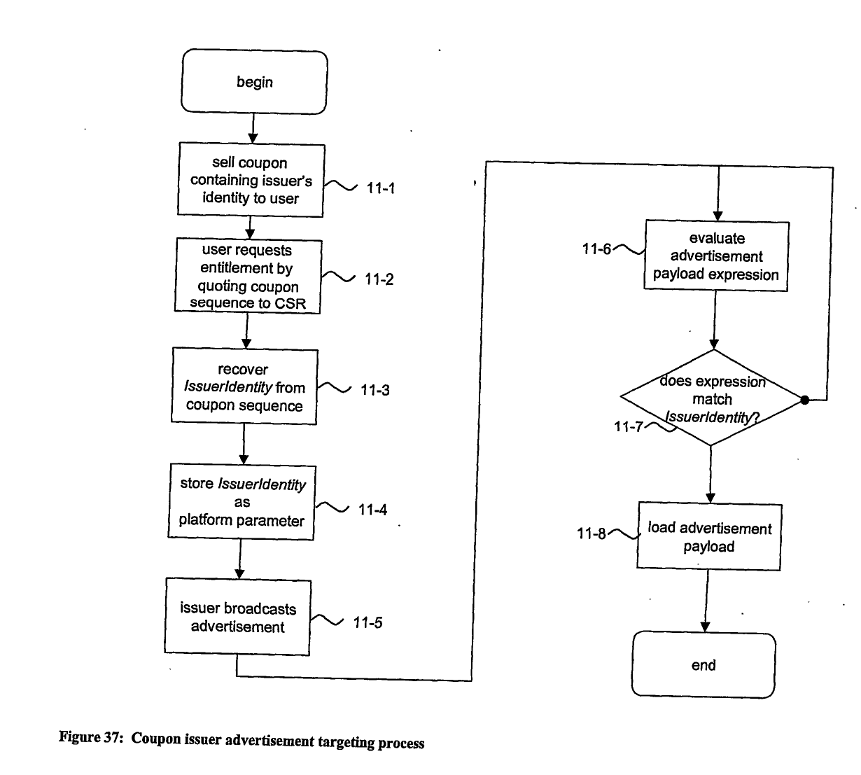

FIG. 37 is a flow diagram of a process for imposing a coupon issuer's identity upon a platform and targeting issuer's advertisements to same platform, and

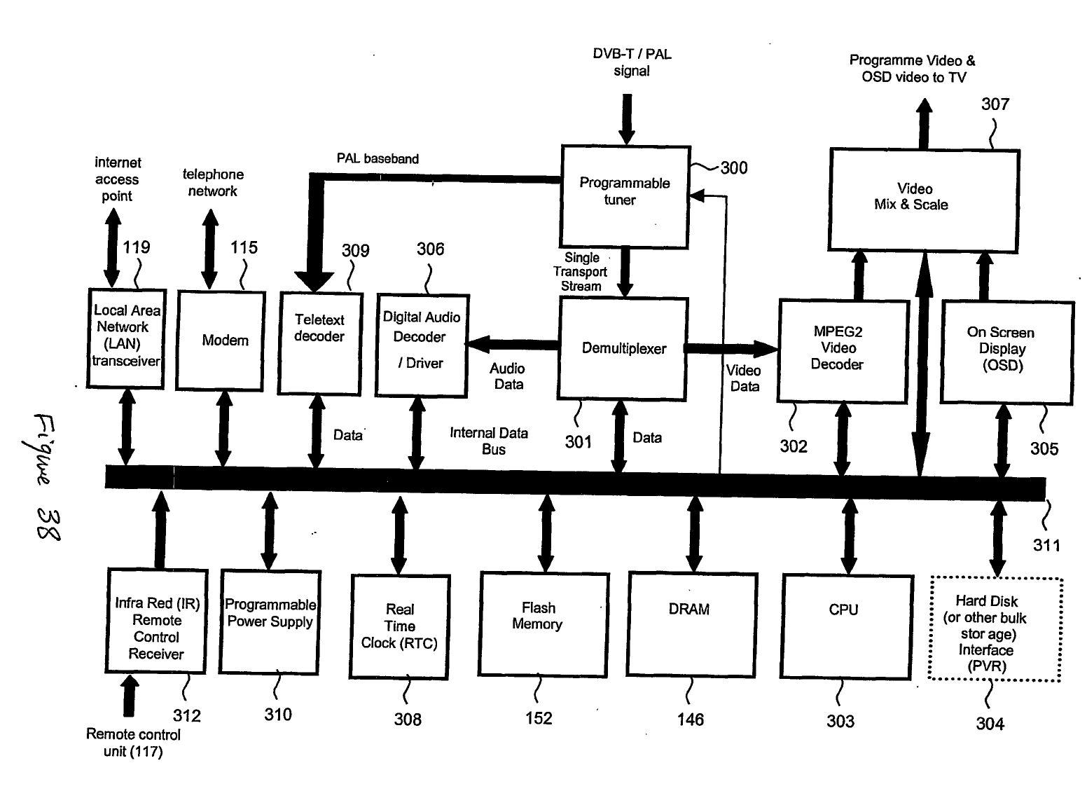

FIG. 38 is block diagram of a set-top box.

### EMBODIMENT OF THE INVENTION

FIG. 1 shows a data centre 100 that receives and aggregates interactive service applications and data from a plurality of interactive service and content providers' databases 101, 102, 103, 104, 105 and 190, and broadcasts said data to a plurality of television receiving platforms 109 as a collection of data streams. The databases may include a television listings database 101 containing television or radio programme listings information such as programme title, start and end times, descriptive text, graphical and audio-video illustrations, including hypertext and metadata. Database 101 may be further complemented by an interactive application database 102 that may include an electronic programme guide (EPG) application for execution and display on platforms 109 where a user may browse through and query said listings content on a television screen. Additionally or alternatively, the system of FIG. 1 may include a database 104 containing interactive educative, informational or entertainment content (such as a television magazine, news, sports or weather), games, quizzes, polls, competitions and other interactive software for execution and display on platforms 109. Additionally or alternatively, the databases may include one or a plurality of issuer databases containing advertisements 190, where an issuer represents either a single promoter (such as a retail store or chain of retail stores) of advertisements or a club of promoters. Additionally or alternatively, a content aggregating intermediary 103 may be provided for collecting SMS (Short Message Service) text, multimedia or other electronic messages from their platforms 109. These may comprise messages from chat services, where users 118 compose messages via the platform 109, or via some other co-located platform such as a mobile telephone, and send the messages directly, or via a message aggregating intermediary 103, to data centre 100. Additionally or alternatively, the databases may include databases 105 containing information and entertainment services carrying, for example, editorial, news, weather or sports results.

FIG. 2 shows the data centre 100 of FIG. 1 in more detail. This contains sub-systems that may either be co-located on one site, or may be geographically distributed across a number of sites and networked together. These include a service aggregation centre 130, a transaction processor 131, a database management system 132, an interactive voice response system 134 and/or a call centre 135. The service aggregation centre 130 receives incoming service content and applications from external parties and processes and compiles said content and applications together to form data streams, which streams are passed to the data carousel 136. The call centre 135 and interactive voice response system 134 are provided for receiving and interpreting user entitlement requests over the telephone. The database management system 132 is provided for managing and storing user and platform information on a database 133, and for communicating transactions to credit card and other payment facilities via a financial backbone 138. The transaction processor 131 is configured to receive entitlement requests from users 118 via the database management system 132, generate entitlement management packets addressed to individual users' platforms 109 and broadcast these to platforms 109 via the carousel 136 for play-out of the data streams at the required time schedules and data rates via the pre-multiplexer 137, which aggregates the streams onto a single data channel. Data streams are fed from the pre-mux 137 to a broadcast multiplex operator 106 and then transmitted from the appropriate broadcast infrastructure 110 using the DVB (Digital Video Broadcasting) family of public satellite (DVB-S), and/or cable (DVB-C) and/or terrestrial (DVB-T) broadcast formats to users' homes.

FIG. 3 shows a typical user's platform 109. This comprises a set-top-box (STB) or personal video recorder (PVR) 114 that receives television services, including the data streams from the data centre 100, from an aerial, satellite dish or cable socket 116 and connects to a television 112 for display purposes via a screen 113 to one or more users 118. Users 118 are able to interact with the data centre 100 by speech or by tapping key sequences via a cordless, wired or mobile telephone 111 that communicates with the data centre 100 via a data and/or telephone network 108. A handheld control unit 117 is provided for controlling the television platform 109. The unit 117 is shown in FIG. 4. Handheld control 117 sends commands to platform 109 preferably by wireless means. In the preferred embodiment, the handheld control 117 uses an infrared transmitter 129 to send commands to platform 109 that correspond to keys as they are pressed by the user, where such keys include: platform power ON/OFF toggle 127, volume up/down 125, channel up/down 126, red/green/yellow/blue fastext keys 124, up/down/left/right cursor keys 120, OK/select key 121, 0-9 numeric keys 123 and a “service” key 128 for invoking some of the platform's interactive services described in this invention. Alternative embodiments for handheld control 117 may include any platform where keys are appropriately labelled to correspond to that of a television control platform, such as may be achieved using a mobile or cordless telephone, a standard “QWERTY” keyboard, a personal digital assistant (PDA), or a touch sensitive, handheld display where portions of the display are marked with labels corresponding to television control commands.

Several other embodiments may exist for platform 109. For example, the functionalities of the STB or the PVR 114 may be integrated, or partially integrated, with the television 112 and/or display 113. In another embodiment the functionality of the STB or the PVR 114 is performed by a personal computer (PC) and the television's display screen 113 functionality is performed by a display monitor. In yet another embodiment, the aerial 116, STB 114, television 112, key control 117 and screen 113 functionalities are integrated into a single handheld platform, such as a cordless or mobile phone, PC notebook, media player or jukebox, palmtop computer or a personal digital assistant (PDA). In a yet further embodiment, platform 109 comprises a local area network (LAN) transceiver 119, as shown in FIG. 5, where data is exchanged between the data centre 100 over the internet 108 instead of via a DVB broadcast infrastructure. Typically in such embodiments, the STB or PVR 114 is connected to the internet via a local, domestic access point 139 by either a wireless (such as via the WiFi or wireless IEEE 802.11a/b/g standards) or Ethernet cable LAN transceiver 119. In such cases, platform 109 may continue to receive television channels and other services by broadcast means via infrastructure 110 and aerial 116. Alternatively or additionally, platform 109 may also receive television channels and other services via the internet 108, access point 139 and LAN transceiver 119. Preferably the LAN transceiver 139 is removable and connects to STB 114 via a connection interface (not shown) such as the industry standard PCMCIA (Personal Computer Memory Card International Association) “PC Card” 68-pin Type I, II or III interface or the USB (Universal Serial Bus) interface.

Platform Memory Allocations

FIG. 6 shows the allocation of memory within the platform 109. An area of STB 114 memory within a volatile portion of dynamic random access memory (DRAM) 146, the so called “canister” memory area 147, is reserved exclusively for storage of downloaded object images 150 that comprise the interactive service from the data centre 100. With current memory costs, the size of the canister memory area 147 is typically 16 or 32 Mbytes. Future embodiments may allocate larger memory areas to the canister 147 and may include embodiments in such platforms as for example personal video recorders (PVRs), where hard disk or magneto-optical disk (such as is widely employed by recordable CD or DVD players) memory is used for canister 147 storage in place of, or in addition to, DRAM. The canister variables CanisterServiceVersion and CanisterShellVersion, 149, correspond to a unique version identity for all objects from the last downloaded service burst and of the loaded shell respectively.

Another area of memory, a so called “scratchpad” area 148, is temporarily reserved for the storage of intermediate results during particular events. The events may be, for example, configuration stream 170 downloads: where the platform searches for, downloads and processes configuration stream data; burst download events 171: where the platform downloads new objects into a buffer area 151 within the scratchpad area 148, processes the objects and writes them to the canister area 147; trigger events and real-time user sessions, where the canister applications 293 execute in the foreground, and background downloading of the configuration 170, delta 172 or trigger 173 streams. Outside these events, the scratchpad 148 is free for use by other non-canister resident applications such as, for example, by a standard MHEG-5 (Multimedia and Hypermedia Expert Group) engine. In the preferred embodiment, the scratchpad area is composed of DRAM but in other platform embodiments, such as within a hard disk based personal video recorder (PVR), the scratchpad may be allocated hard disk memory storage, or a combination of hard disk memory and DRAM. A small area of DRAM is additionally allocated to storage of transient platform parameters 154 that denote the status of the platform's connectivity to outside devices such as, for example, whether the platform is connected to a LAN transceiver 154 or modem 115 device and the details of the device(s) that are connected. The transient parameters 154 are updated by the canister loader program 140 upon power up of the platform from cold and periodically thereafter by polling of external connection interfaces such as USB or PC Card ports.

Portions of non-volatile, flash memory 152 are also allocated to storage of firmware and data associated with maintenance of the canister 147 and the applications 293 stored within it. The firmware includes a canister loader 140, which is executable code that controls the download of objects from burst streams 171, and generates a data image 150 within the canister 147. Preferably, only a minimal “bootstrap” component 140 of the canister loader is present in flash memory 152 as firmware, and where the remaining “transient” portion 153 is loaded to volatile memory 146 at the commencement of downloads from burst events 171 and is wholly or partially erased afterwards. Also stored in flash 152 are decoders and translators 141. These are software modules that can be called by the canister bootstrap loader 140 and/or transient loader 153 to process downloaded objects. For example, the canister loader may first be required to invoke a decryption decoder to render an object to clear text.

Another decoder may be subsequently invoked to decompress the clear text object. Preferably, all executable objects are broadcast in a platform independent form. Preferably, the canister loader invokes a translator to convert platform independent executable objects to a form where they are directly executable by the platform's central processor unit (CPU). A platform adaptation layer 142 is also stored in flash 152. This includes objects comprising components of an operating system or kernel 288 and libraries 289, which the canister applications 293 can exclusively call directly, are downloaded into the canister 147. The platform adaptation layer 142 is platform specific code that binds the canister operating system image 288 and libraries 289 to the platform's native drivers and operating system 290 (STAPI and OS20 in the preferred embodiment) and hardware (STi5517 in the embodiment described). The operating system layer may contain a JVM (Java Virtual Machine) 294 to support execution of applications 293 loaded to the canister in Java bytecode form. The operating system 288 may contain communication protocol software, such as TCP/IP (Terminal Control Protocol/Internet Protocol), to allow applications 293 to receive and transmit data across the internet.

Other firmware and data that are stored in flash 152 include platform parameters 143, platform cookies 144 and application cookies 145. The platform parameters 143 may be brand, model number and hardware characteristics such as CPU speed, screen resolution, size of canister, scratchpad memory allocations and types of connection interfaces (e.g. PC Card, USB, SD Card) attached, if any. These are burnt into non-volatile memory during manufacture and are read only throughout a platform's service life. The platform cookies 144 are small data files that comprise platform configuration information, such as the ServiceID or entitlements (see later), which must survive power loss. The application cookies 145 are small data files that hold certain states of an application 293 that are to be restored the next time it is invoked. For example, an electronic programme guide application 284 may permit a user to remove or order certain channels in his/her set-up preferences by saving said configuration as a cookie 145. Or, for example, a game application 283 may log a user's name and high score as a cookie 145. Or, for example, an entitlement may have been downloaded and stored as a cookie 145 for later reference by an application 293 to determine whether access is to be given to all or certain portions of its features or content 292.

Canister Structure

FIG. 7 shows the structure of programme software, data and service content stored within canister 147. Preferably, the data loaded into the canister comprises a layered software stack that is functionally identical across canisters in other platform hardware types and includes driver software 290 that controls platform 109 programmable hardware (such as, for example, display controllers, sound generators, tuners and de-multiplexers) via platform adaptation firmware 142 corresponding to a particular platform hardware configuration. Appropriate hardware device drivers may be loaded and linked into driver software 290 conditional upon the values of transient platform parameters 154 that denote, for example, whether platform 114 is connected to a LAN transceiver 119 or modem 115.

Preferably data loaded into each canister also comprises an operating system 288 and libraries of executable code 289 that may be called via a single canister application programming interface (API) 291 by applications 293 resident within the canister 147. Preferably each application 293 may have associated with it data or content 292 which it may process. Preferably, the applications 293 include one or more game application(s) 283, an electronic programme guide (EPG) application 284 a chat application 285 and a graphical and hypertext browser 287. Media player applications, such as audio video players, may be loaded and linked into application software 293 conditional upon the values of transient platform parameters 154 that denote, for example, whether platform 114 is connected to a LAN transceiver 119 or modem 115.

Burst Stream

The canister 147 is loaded with data comprising one or more objects from a burst stream 171. A low bit rate continuous configuration stream, 170, broadcasts download parameters such as time of day, duration, transport stream location to enable the platform to download from the burst stream 171 according to processes described herein. Another broadcast stream, the delta stream 172, enables the platform to update itself with more recent data since its last download from a burst stream 171 according to processes described herein. Another stream, the trigger stream 173, broadcast in the same transport stream alongside the currently viewed television programme carries interactive applications for loading and execution by the platform according to processes described herein. Yet another stream, the transaction stream 174, contains addressed entitlement information that determines the degree of service offering and access available to individual platforms as later described.

Each burst stream 171 has typically a duration of 15 to 120 minutes and a high bit rate, typically 64-256 kbit/s, compared to the other streams 170, 172, 173 and 174 in order to minimise platform power up times during download. Typically, 3 to 4 bursts 171 are broadcast daily at roughly equal intervals. FIG. 8 shows the overall sequence of objects conveyed in each burst stream 171. The first object broadcast is the root object 180, whose Identity 201 is always null, which is followed by other objects 181, 182, 183, see FIG. 9, in an order such that no object is broadcast until all other object(s) that reference it, if any, have been broadcast beforehand. Finally, an “end of objects” marker 184 is broadcast to delimit the end of burst stream 171.

Objects may comprise any type of binary data, including application and/or operating system and/or driver executables in any format (i.e. including Java bytecode or script, Pascal p-code, Intent VP code, machine codes native to the platform's CPU, source codes), content of any type (i.e. including text, graphics, sound, audio and/or video clips, movies, conditional access entitlement) whether or not stored in compressed and/or encrypted form. FIG. 9 shows the structure linking the objects carried in the burst stream 171. Canister loader 140 constructs a memory image in the canister based around a connected network of object payloads that are referenced by one or more “shell” objects 181. Only one shell object 181 may be downloaded to a given platform canister, and whose identity is determined for a given platform by evaluation of logical expressions within root object 180 which are functions of platform parameters 143 and/or transient platform parameters 154. A service corresponding to a subset of objects that connect directly or indirectly beneath a particular shell object 181 is referred to hereafter as a “shell service”.

A shell object 181 may differ from another shell object in the sense that, while linking indirectly to content objects 183 that cause a service to appear identical to users, it may link directly or indirectly to object payloads that contain a different operating system, e.g. one shell links objects into the canister 147 comprising Multimedia Home Platform (MHP) middleware while a second shell object, for example, might link in a proprietary operating system such as PSOS or Intent, while a third, for example, might layer MHP over a proprietary operating system. As industry acceptance of application programming interfaces (APIs) evolves, both manufacturers and broadcasters may seek to alter the middleware in order to adapt to changing industry needs. By regularly broadcasting and up-dating full canisters of firmware and applications within memory, major benefits can be provided to users, manufacturers and broadcasters because platforms 109 can be more easily and quickly updated compared to a conventional approach of burning middleware or other firmware into flash memory.

Further, visible differences may exist between two shell services ruling on different platforms but where no or limited structural or programming differences exist between the groups of objects in their respective canisters. For example, a shell service may differ only in terms of its “skin” (i.e. the style, screen backgrounds or appearance of the service to the user) but be identical in terms of the functionality and content it displays. This is especially important for manufacturers who need to show, at minimum, differentiation in terms of aesthetics and appearance from similar services displayed on other manufacturers' products.

A single burst 171 may support a diversity of multiple, different platform types. For example, the service operator may support two shell services: one serving set-top-box platforms, and another serving, say, personal video recorders. Whereas, both services may convey essentially the same content, certain executable objects may be required for one platform but not the other—and vice versa. Similarly, certain content objects may be designated for storage on one platform but may not, possibly for reasons of size, be designated for use on other platforms.

Platform Configuration

FIG. 10 illustrates how the data centre 100 broadcasts a number of data streams throughout a day, keeping the canister 147 up to date and filled with applications and other objects. Platforms 109 periodically power up their tuner and data receiver stages at the beginnings of burst streams 171 to reload their canisters. Timing and location information to allow platforms to determine when and on which transport stream the next burst event will occur are carried in configuration streams 170. Configuration stream 170 is a perpetual, repeating (typically every few seconds) low bit rate stream, typically less than 2 kbit/s, carrying service configuration and system data such as time, the locations of all data centre 100 streams, ConfigurationTable 162, and schedules and locations within transport streams of all forthcoming burst events 171 within the near future, BurstEventTable 163, typically within the next 24 hours. Burst events may be broadcast for different services, see FIG. 11. For example it may be possible to receive channels on two DTT networks near the French-German border, as FIG. 11, in which case different service identities 207 are broadcast to support each.

FIG. 12 illustrates a perpetual loop whereby the canister loader 140 periodically reads the configuration stream to determine when and on which transport stream the next burst event will occur. While the platform is in standby mode (1-1), the canister loader stays within a loop where, every 2 hours (1-9) triggered by a clock component 308, it sends a “power on” command to the programmable tuner 300 and de-multiplexer 301 components (1-10) and next acquires data from the configuration stream according to the LoadConfiguration process (1-11) (see later) and then powers down the programmable tuner and de-multiplexer components (1-12). If the platform is already in an active mode (1-1), there is a probability that the platform is in use. The canister loader must determine that the platform is not in use before tuning away to the configuration stream 170 in order to prevent interruption of viewing in single tuner platforms. This is described as follows. The canister loader determines whether the current time is within a user permitted download window (1-2). This window may be changed by the user via a set-up menu and is typically set by default to the early morning. Given that a channel change is likely to be required in order to acquire the configuration, the canister loader attempts to minimise disruption to any viewing activity by attempting the acquisition only after a minimum period of user inactivity has occurred (1-3), after a minimum period has elapsed since the last configuration load (1-4) and the last attempt to seek a user acknowledgement (1-5). The inactivity period is 4 hours by default, but can be changed by the user via a setup menu. At which time, the canister loader overlays a message onto a portion of the screen warning that a configuration load will occur if the user does not acknowledge by hitting a key on his/her handheld control (1-6). If no user acknowledgement is given within a few seconds (1-7), the canister loader saves the platform's current tuned channel settings to memory (1-15), initiates the LoadConfiguration process (1-14) and then restores channel tuning to the last channel viewed by the user (1-13). If a user acknowledgement is given (1-7), the canister loader aborts its attempt to download, resets the inactivity countdown timer (1-8) and returns to the loop.

FIG. 13 is a flow diagram of the LoadConfiguration, whereby the canister loader 140 determines the parameters associated with the next burst event. Canister loader searches the transport streams for a valid configuration stream (2-2). If a configuration stream is not found (2-3), the canister loader displays a diagnostic message to screen (2-9), otherwise it loads the current time and date from the configuration stream and sets the platform real time clock accordingly (2-9). Next, canister loader 140 looks in the non-volatile memory area for the platform cookie 144, ServiceID, that identifies which service or services, the platform has previously been configured by the user to receive and load into canister 147 (2-5). If the ServiceID cookie exists then canister loader 140 looks up the identity of the next burst event, BurstID, that corresponds to ServiceID (2-10). If the ServiceID cookie does not exist (i.e. because the platform is new), or its value cannot be found in the BurstEvent table, the user is invited to select via a pop-up on-screen menu a service from those featured within the BurstEvent table.

Given that a plurality of consecutive burst events 171 may carry identical objects (i.e. because a more recent version of the service compared to what is held in the canister is not yet scheduled) it is undesirable for the platform 109 to waste power by waking from standby to download the same objects multiple times. A means whereby the canister loader 140 avoids downloading the same data already present in the canister is desirable, and is achieved by adding to the BurstEvent table a service attribute, ServiceVersion, that is unique for each set of objects of a given service identity 207 that is carried within a burst event. Each time canister loader 140 loads a shell of objects to the canister, it writes also two variables, CanisterServiceVersion and CanisterShellVersion, into the canister 149 that correspond to unique versions for all objects within the service and the loaded shell respectively (2-14). Hence, the canister loader determines first whether ServiceVersion and CanisterServiceVersion match (2-6, 2-7). If they match, then a download from burst event 171 corresponding to BurstID is omitted and the process for configuring the next burst event ends (2-15). Second, the canister loader determines whether ShellVersion and CanisterShellVersion match (2-8, 2-12). Finally, if no match is found between either the service or the shell versions, the canister loader writes the BurstID, NextBurstTime and NextBurstTransportID into the platform cookie area 144 (2-14), so that the platform is now properly configured with the next burst event's time and location, whereupon the LoadConfiguration process ends (2-15).

Delta Stream

Burst stream events 171 occur only periodically during a day. A repetitively broadcast, carousel stream of updated objects is broadcast between burst events, referred to as the delta stream 172. FIG. 14 shows the structure of the delta stream, and illustrates a case where newer versions of certain objects 185 have become available for broadcast since commencement of the “B” burst event 171 described with reference to FIGS. 9 and 10. Broadcast of these updated objects 185 is delimited by a beginning of carousel marker 186, followed by the updated objects 185 and terminated with an end of carousel marker 187. The broadcast is repeated on delta stream 172 normally for at least 24 hours, or until a burst event 171 that includes the updated object versions (event “C” in FIG. 10), or newer versions still, has ended. An example is a modified news object to reflect a news bulletin or an updated television listings object to reflect a schedule change. Delta stream 172 has a low bit rate, typically 13-32 kbit/s, compared to the burst stream.

In platforms where a second tuner is available for use, the delta stream 172 may be monitored and processed by the platform continuously so as to ensure that the canister is always up-to-date during a user session. In single tuner platforms, the user manually requests an update from on an screen menu to invoke a canister application 293 that causes the platform 109 to re-tune to receive and process the delta stream 172 in real-time. For example, a user may select, say, a “listings update” feature within an IPG application 284 to cause it to invoke the canister loader 140 for the purpose of updating listings content objects 281.

FIG. 15 describes the process, LoadDelta, whereby canister loader 140 tunes to the delta stream 172 to parse and replace old canister objects with newer ones found in the delta stream 172. First, the canister loader saves the programmable tuner's existing settings (3-2), reads ConfigurationTable to determine on which transport stream and data stream identity (packet ID) the delta stream is to be found (3-3) and then sends a command to the programmable tuner and de-multiplexer to filter on the delta stream (3-4). The canister then waits until a beginning of objects marker 186 is received before invoking process LoadDeltaObject to process each object (3-6). The LoadDeltaObject is illustrated in FIG. 16 and is essentially a simplified form of LoadBurstObject, except that old object images are erased from the canister (4-15) as each new image is added preferably using a “double buffer” method where, in order to guard against data loss, the old image version is unlinked and deleted only when the new image has been fully written into the canister and linked to other objects.

Optionally, either the entirety or a subset of the canister may also be broadcast continuously within the delta stream. This is useful to users who are powering up their platforms from a powered off state, or whose platforms are new and being used for the first time, and where users cannot wait until the next Burst event and need quickly to reload their canisters so that the platform becomes useable. In such cases the user manually initiates the download process LoadDelta, as illustrated via a setup menu and where the canister loader processes objects in real-time from the delta stream 172 in place of the burst stream 170.

Trigger Stream

The canister 147 may provide interactive functionalities that complement or enhance viewing of conventional television channel services. During such services, small trigger data objects are broadcast in the same transport stream or multiplex as the television channel event so as to activate specific portions of an application that are already stored in the canister 147.

FIG. 17 shows a conventional television service channel displayed 220 on screen 113. As shown in FIG. 18, a canister resident application 293 can be caused to display a first overlay 270 over channel display 220, responsive to a triggering signal carried within the same transport stream as the television service and generated by the television channel play-out facility 107. The video 220 may be scaled down, simultaneous to the appearance of overlay 270, to any size within the screen so that the video and pop-up overlay 270 can appear simultaneously on screen 113 without overlap between them. Overlay 270 may be opaque and obliterate the portion of video 220 it covers or, alternatively, it may be translucent so that the covered video 220 is partially visible through overlay 270. The overlay 270 may be any size or shape, such as circular, oval or rectangular, and be positioned anywhere on the screen 113. The overlay may contain an instruction telling the user which keys to press on his/her handheld control 117 to cause second and subsequent overlays 271, such as shown in FIG. 19, to appear. All overlays may contain interactive display components such a text labels 272, static or moving graphics 274 and a highlighting effect 273 so as to illustrate an area of focus to the user within said overlay, where a user may press a key (the “OK” key 121 in the example overlay 271 illustrated) on handheld control 117 to select a process for execution within the interactive application 293 associated with said highlight 273.

FIG. 20 shows the process, TriggerStreamHandler, employed to cause applications 293 to overlay the screen during conventional television viewing. First, TriggerStreamHandler process is started when the platform 109 is powered up from power off or standby mode and runs continuously in the background monitoring which television channel the platform is tuned to (5-1). Each time a channel change occurs (5-2), the new channels service and transport IDs are acquired (5-3) and looked up (5-4) in ConfigurationTable to determine whether an identifier for the trigger packet stream PID can be found (5-5). Assuming a trigger PID exists, TriggerStreamHandler reads the next trigger object into scratchpad 148 (5-7) and checks that it is not corrupted and authentic before decrypting (5-8, 5-9).

FIG. 21 shows the structure of a trigger object Trigger objects have identical structures to burst or delta objects 200, and each potentially may carry multiple trigger payloads 299. The payload expressions 295 determine whether their payload attached 299 is relevant to the currently viewed channel. If so, the payload is downloaded (5-11, 5-12). Unwanted payloads are erased. Trigger payloads 299 are generally small and, typically, a payload contains only a single decoder/translator 281 known as a “trigger handle”. The trigger handler is executed (5-15) and may be accompanied by a binary image 282 containing information linking the identity of a particular television service channel 295 to a particular canister application 296 in order to convey a message “token” 297 at a particular time or upon the occurrence of particular timestamp (carried within the tuned transport stream) 298. The trigger handler 281 starts the identified application 293 if it is not running and communicates token 297 to the identified application 293 which, in turn, causes overlays 270 and 271 to appear on screen 113.

Transaction Stream

An individual platform addressable, “Transaction” stream 174, is broadcast continuously throughout the day. The Transaction stream contains feature entitlement information that is addressed to individual platforms, the process for which is described in detail later.

Objects and Payloads

A shell object 181 links to one or more operating system objects and to one or more application objects 182, each of which in turn may link to other objects 183. An object may be linked to by multiple objects, but is broadcast only once during a burst event 171 to conserve bandwidth. The canister loader writes all the objects carried on the burst stream into a buffer area 151 within the scratchpad where they are processed, before writing to the canister the linked root, tree and branch of objects applicable to each—as described below

Each object is preferably transmitted as one or more modules using the so-called DSM-CC (Digital Storage Media Command and Control) carousel 136. The DSM-CC carousel is a data stream transmitted by the broadcasting station alongside audio-video data in which a sequence of modules is transmitted, where each of the modules comprises executable code and/or data components of one or more data sets that may be downloaded by the STBs. All objects are tagged with an identity, ServiceID, 207 of the service to which they belong. For example two burst events 171 may co-exist on the same stream (e.g. a French service and a German one). All objects comprise the structure described in FIG. 22. Each object also has an Identity 201 for the purpose of being linked to by other objects. All objects have an integer Version 202 associated with them. Objects that have been updated since a previous broadcast (for example, an object containing television listings may have been updated since its broadcast in an earlier burst event), carry incremented Version integers compared to the respective previous values. An object may carry a signature and/or checksum 203 to authenticate its integrity. An object may carry multiple payloads 205. Payloads are embedded within a case statement so that, normally, only one payload is chosen by the Canister loader for loading into the canister according to whether its associated logical expression 204 is true. The canister loader contains an interpreter with which it evaluates on the fly logical case expressions. Expressions are logical functions of operators, platform parameters 143, transient platform parameters 154 and constants. Operators may include arithmetic operators (plus, minus, multiply and divide), logical (NOT, AND, OR), inequalities (<=, >=, <, >, !=, ==), string operators (LEN, FIND), wildcard (*, ?), memory peek and array pointer operators. Platform parameters and constants may be of type character, short and long integer, float, string, time/date and boolean. Expressions containing a reference to a platform parameter 143 or transient platform parameter 154 that is not satisfied are evaluated as false.

Downloading Objects From the Burst Stream

FIG. 23 describes a perpetual loop whereby the canister loader 140 periodically reads the burst stream 171 in order to regenerate the canister 147. While the platform is in standby power mode (6-1), the canister loader reads a clock to determine whether the time is within a guard time (15 s) of the next burst event (6-8), as previously determined by the LoadConfiguration process. If so, the canister loader sends a power on command to the programmable tuner and de-multiplexer components (6-9), and initiates the canister download LoadBurst process (6-10) (see later), followed by the LoadConfiguration process (6-11) to acquire details of the next burst event, ending with sending a “power down” command to the programmable tuner and de-multiplexer components (6-12) before repeating the loop.

If the platform is powered up (6-1), the canister loader determines whether the current time is within a user permitted download window (6-2)—where the window is the same as described earlier for loading of configuration parameters. Given that a channel change is likely to be required in order to acquire the burst event objects, the canister loader attempts to minimise disruption to the viewer by attempting the acquisition only after a sustained period of user inactivity (6-3, 6-4). The inactivity period is 4 hours by default and can be changed by the user via a setup menu. At which time, the canister loader overlays a message onto a portion of the screen warning that a configuration will occur if the user does not acknowledge by hitting the “OK” key on his/her handheld control (6-5). If no acknowledgement is given (6-6), the canister loader saves the platform's current tuned channel settings to memory, initiates the LoadBurst process (6-15), followed by the LoadConfiguration process (6-14) and then restores channel tuning to the current channel (6-13). If an acknowledgement is given (6-6), the canister loader aborts its attempt to download, resets an inactivity countdown timer (6-7) and returns to the loop.

Loading the Service and Remaining Object(s), if Any

FIG. 24 shows the process, LoadBurst, used by the canister loader for parsing all objects broadcast in the burst stream. The process starts with formation of an empty table in memory (7-2), UnsatisfiedLinks, that accumulates link references during the load, then by loading the first, root object 180 into the scratchpad area 148. Preferably the bulk of the canister loader's functionality is contained within a downloaded, “transient” image 212 carried within payload(s) 205 of root object 180. The first object, the root object 180 always has a null (0) Identity 201 and is downloaded by the bootstrap portion of the canister loader 140. The root object's payload expression(s) 204 is(are) evaluated to determine which payload is to be used. Preferably, the root payload contains the remaining “transient” component 153 of the canister loader in a platform independent form. If the payload's binary image is in a compressed or platform independent form, the payload contains references 210 to one or more decoders and/or translators 141 in firmware 152 which are invoked in sequence to render the image to an executable form. An approach of translating executable images to machine code immediately after their downloading benefits the speed of application execution compared to real time command interpretation popularly used by many middleware environments. In the preferred embodiment, the virtual processor operating system 288, Intent, is employed within the canister so that a virtual processor (VP) translator 141 is employed to convert executable objects downloaded in a generic machine code representation to the specific, native machine code instruction set and hardware environment employed by the host platform. Finally the image is executed to invoke the canister loader's full functionality as described below.

FIG. 25 illustrates the process LoadBurstObject (7-4, 8-1) used by the canister loader to parse each object, including the root object 180 and is further described as follows. The next object header is read (8-2) and, unless it is the root object 180 (8-3), the object's Identity 201 is looked up in UnsatisfiedLinks to determine whether it has been referenced by a previously loaded object. If the object's Identity is present in UnsatisfiedLinks (8-4) then the canister loader determines whether an object with the same Identity and Version has already been loaded into the canister (8-5, 8-6). If not, the raw object data is written to an area in scratchpad memory (8-8) where its signature and/or checksum is checked to verify its authenticity and that it is error free (8-9). Assuming the object is authentic and error free (8-10), it is decrypted to clear text (8-11) whereupon, in cases where the object comprises multiple payloads (8-12), payload expression(s) are evaluated to determine which payload is to be processed and loaded (8-13). The canister loader then executes the coders and translators referenced in the payload's header (see FIG. 26) to process the payload's binary image 212 sequentially (8-14, 8-15, 8-16) and write the result to memory at destination or file pathname address 211 (8-17). The destination address 211 refers to a memory location within the canister 147. Additionally, the destination address 211 may refer to additional locations such as within the buffer memory area 151 or other memory areas within the platform. For example, application payloads 205 may download in real time from the trigger stream may be loaded to temporarily unused memory resource elsewhere within a platform (for example, the scratchpad and buffer memory areas reserved for an MHEG-5 engine in a digital terrestrial television receiver).

Next, the canister loader reads each object link, if any, referenced by the payload and checks to determine whether each referenced object has already been loaded to the canister (8-18, 8-22). If a referenced object has not been loaded, its identity is added to the UnsatisfiedLinks table (8-23, 8-24). Finally, the loaded object's entry in UnsatisfiedLinks is removed (8-20).

The parsing process continues for all objects until a broadcast end marker 184 is reached (7-3), whereupon the transient canister loader component 153 or a substantial proportion of it, if any, is erased (7-6) from the scratchpad area 148. A proportion of the transient loader may persist in scratchpad or alternatively may be located in the canister for the purpose of processing delta streams 172 and trigger streams 173.

Service Entitlement

Because object downloading normally only occurs at scheduled times, as opposed to in real-time during a session when a user may seek entitlement to use or view them, all objects belonging to a shell are loaded to the canister in advance of a session and irrespective of whether a user is entitled to access the functionalities or view the content they contain. Consequently, a method is desired whereby certain functionalities within applications can be activated or “entitled” in real time by a user. This is described below.

FIG. 17 illustrates a viewing screen 113 where a user 118 watches video 220 as either a telecast television channel or as a video segment that is being played out from storage local to the platform, and where the user has selected using the “Service” key 128 on handheld control 117 the canister's interactive services to which he/she may or may not currently possess an access entitlement. A “call to action” overlay 221 appears on the screen 220, as shown in FIG. 27, to inform the user of the entitlement proposition and to give instructions on what to do to obtain entitlement. The video 220 may be scaled down to any size within the screen 113 so that video 220 and pop-up overlay 221 can appear simultaneously on screen 113 without overlap between them. If the video is played out from local storage, it may be paused while the overlay is displayed. Overlay 221 may be opaque and obliterate the portion of the video 220 it overlays or, alternatively, it may be translucent so that the covered video 220 is partially visible through the overlay 221 which may be any size or shape, such as circular, oval or rectangular, and be positioned anywhere on the screen 113.

Alternatively, only certain objects associated with a shell may require verification whether a user is entitled to access. For example, the first level of an interactive game application object may be accessed by all users irrespective of whether they have an access entitlement. However, subsequent levels within the game may require the user to have taken out, say, an annual subscription to play all games or some other form of entitlement, such as pay per play of an individual game, in order to play the game's higher levels. An electronic programme guide application 284, where certain of its features or certain of its content 281 require some form of paid entitlement to use or view them, is another example.

Preferably, the platform contains or is connected to a modem 115 or LAN platform 119 so that the user may select a desired entitlement option without placing a manual telephone call by using the cursor keys 170 on his/her handheld control 117 to move a highlighting effect from one to another of a plurality of text areas or to areas associated with text labels within the pop-up. The highlighting effect signifies user focus on the screen and may be a cursor or some other icon marking the text, or it may be a changed border surrounding the area, or a changed area background or pattern or a changed font style, or a flashing effect, or some combination of the aforementioned.

In the preferred embodiment a user can, while watching a full screen telecast television channel or while playing a television programme stored within the platform 220, causes the canister's applications and services to be displayed as an interstitial menu 240, illustrated in FIG. 28, by pressing the “Services” key 128 on his/her handheld control 117. The screen displays a plurality of labelled cells, each corresponding to a different service (e.g. program guide 227, games 228, shopping 229) within a menu area 231, where one cell is highlighted 228. A second area of the screen 226, that does not overlap with the menu area 231, gives notes and information concerning the highlighted service option 228 and may be periodically overlaid with an advertisement panel of same shape—see later. The user may press the cursor keys 120 to move the highlighting to another cell within the menu area 231, whereupon the contents of the notes area 226 may change in response to the newly highlighted cell. A scroll arrow 230 appears when a user can navigate the highlight in the direction of the arrow 230 to a cell which is currently not displayed or is outside the menu area 231. Simultaneous to the menu and notes areas, a third non-overlapping area 224 may display a reduced scale video window 220 corresponding to the telecast channel or television programme previously played to full screen. A user may attempt to activate the service corresponding to the highlighted cell 228 by pressing the “OK” key 121. If the user is not currently entitled to access the application 293 corresponding to the cell 228, the notes area 226 is replaced by instructions 241 inviting the user to select from one or more payment options as shown in FIG. 29. Preferably the options correspond to cells 242 which a user may navigate highlighting 243 to and select by pressing the “OK” key 121. In such instance, the highlighted application 228 in the menu bar 231 is highlighted differently 243 after it is selected to signify that focus has switched to 243 one of a second series of options 242 in the notes area 241. Alternatively, if the user is entitled to access the highlighted option 228, the application corresponding to it is invoked, or a second level menu of service application cells is displayed as shown in FIG. 30.

Any executed object, either at the onset of or at some later point during its execution, can cause a call to action pop-up to be displayed on the screen. For example, FIG. 31 shows a game that has been partially played, where the user has met some criterion that permits him/her to access other functionality within the application. The user is invited to select the new functionality by pressing the “ [symbol] ” (right arrow) key 120 on the handheld control unit 117, causing the overlay 260 of FIG. 32 to be displayed.

FIG. 33 describes the case where a LAN platform 119 or modem platform 115 is fitted to the platform and where the user has met some criterion within an application, as previously described in FIG. 31, and where the user is invited to purchase an entitlement by making an impulse response. In this case, when the right arrow key is pressed, the application causes an overlay 260 to be displayed that contains user instructions and a plurality of entitlement options including the option to back out or not to purchase an entitlement. The user navigates the highlighted cell 243 to the cell 242 corresponding to his/her desired option and presses the “OK” key 121. A modem 115 or LAN platform 119 connection is then established with the service provider, whereupon an entitlement message is either broadcast to the platform 109 or returned to the platform via the telephone network 108 and modem 115 (or via the internet 108, access point 139 and LAN platform 119) which causes the platform to execute the application, or execute the next level of the application as shown in FIG. 34.

A process of broadcasting positive and negative entitlement messages is used to control individual user access to the platforms. This process is illustrated in FIG. 35 and is described as follows. An application 293 causes a call to action pop-up 241, 260 or 270 to be displayed to the screen (9-5) where it has determined (9-3) that the user is selecting pay functionality (9-2), where (i) a user had attempted to use a part of that application's functionality to which the user is not currently entitled (e.g. selecting a pay game, or selecting a pay feature within the program guide), or (ii) the user's interaction history with the application has met some criterion embedded within the application's functionality (e.g. minimum game score exceeded).

The application searches within the Applications cookies region in flash memory for the correct entitlement message name EntitlementName (9-3). If one exists and its contents are valid (see later) then access is granted to the pay portion of the application (9-4). A call to action message is displayed on screen (9-5) for the user if valid entitlement message contents are not found. The user decides whether (9-10) to request entitlement or whether to abandon the request and return to the non-pay components of the application's functionality (9-11). The application determines whether a modem 115 or LAN platform 119 is connected to STB 114 (9-9) and, if so, whether it can make a connection (9-7). If so, an automated method AutoEntitlement is used (9-6).

If a modem or LAN platform does not exist, or a connection cannot be established, then the application uses the method ManualEntitlement (9-8, 10-1), see FIG. 36, which is described as follows. The method causes entitlement information to be broadcast to a user's platform in real-time and has the advantage of speed and simplicity in that it does not require the user to key in a password or number sequence. The application first freezes any on screen television video and stores current channel tuning settings (10-2) (so that these may be restored later). The application sends a command to the programmable tuner 300 and de-multiplexer 301 to cause the platform to tune to the multiplex carrying the transaction stream 174, de-multiplex and filter it according to its packet ID (PID) and transport stream identity as recovered from ConfigurationTable (10-3).

If the transport stream is not found (10-4), (e.g. due to a signal coverage problem), then a diagnostic message (10-10) is displayed to screen and the process ends (10-20). Otherwise the application looks up to determine whether the platform has a BroadcastAddress already assigned to it (10-5). If no BroadcastAddress has been previously assigned, a random number is generated for BroadcastAddress which is written to non-volatile platform memory 144 (10-11). A checksum, typically an additional group of 3 to 5 digits, is added when displaying BroadcastAddress on screen to assist recognition by the call centre 135 of user misquotes. BroadcastAddress is represented preferably for display purposes to base 33 as uppercase alphabetic and numeric characters, where 3 characters (O which looks like zero, 1 which looks like I, Q which looks like zero) are not used to reduce user recognition errors, in groups of 3 to 5. A call to action 260 is displayed to screen (10-6) advising the user of the entitlement proposition describing: service features and benefits, price, telephone number to call to activate the entitlement and BroadcastAddress to quote. Then the application filters for an entitlement message broadcast to it which, when downloaded, has the identity EntitlementName (see later).

The user dials the call centre 135 using the telephone number displayed (10-7). The call centre's customer service representative (CSR) answers the user's call (10-8). The user gives the CSR his/her contact and payment details (10-9) to initiate payment transaction. Payment details may comprise either credit card details or a coupon entitlement sequence (see below). The user reads the BroadcastAddress off the screen to the CSR (10-12). The CSR verifies the payment transaction and checks within his/her database to determine whether an identical BroadcastAddress value has been previously assigned to another platform (10-13). If so, the CSR asks the user to key into the handheld control a key sequence (10-22) that causes the platform application to generate a new BroadcastAddress and redisplay it to screen within the call-to-action overlay (10-21), whereupon the CSR asks the user to read it out again so that the process of checking its uniqueness can be repeated. When the BroadcastAddress is verified by the CSR to be valid and unique (10-13), the CSR causes an entitlement message to be broadcast to the address BroadcastAddress platform address (10-14). The entitlement message comprises a data packet containing the following information: BroadcastAddress [, . . . BroadcastAddressM]: where [ . . . ] contains optional broadcast addresses for other platforms that are to receive and process the same message; EntitlementName is the name of the entitlement message, for platform file system storage and later retrieval purposes by applications; Functionality1 [, . . . FunctionalityN]: where Functionality1 is a unique identifier for a particular functionality within an application or group of applications, to which access is to be entitled, and where [ . . . ] contains optional references to other functionalities whose access is to be granted by the same message; StartTimeDate:ExpirationTimeDate: where StartTimeDate is the time and date from which access shall commence, and ExpirationTimeDate is the time and date on which access shall expire; UseCount is the maximum permitted number of cumulative uses of the functionality within the application or group of applications (0 implies unlimited); UseTime is the maximum permitted cumulative usage time of the functionality within the application or group of applications (0 implies unlimited); [IssuerIdentity] is the optional identity of the issuer who sold the subscription—this will be discussed in more detail later. These parameters allow entitlement messages to be used to control access on either a basis of elapsed time, number of play sessions or duration of play sessions, or combinations thereof. It will seen to those skilled in the art that additional flexibility may be obtained for the user entitlement process through additional parameters in entitlement messages, such as prepay tokens.

The platform downloads the entitlement message and stores it within its filing system in a non-volatile memory area as EntitlementName (10-15). As soon as the platform application recognises the existence within the platform filing system of a new message, EntitlementName, it opens the message to read the entitlement parameters.

Assuming these are valid, a message acknowledging the entitlement is displayed to screen (10-16), and the CSR asks the user to acknowledge that he/she has received the entitlement on screen (10-18). If the user acknowledges, the CSR thanks the user and both hang up. If the user does not acknowledge, the CSR attempts to resolve the problem with the user which, if unsuccessful, may result in the CSR scheduling a disentitlement message to be sent during one or more of the next data stream bursts (10-23).

Coupon Entitlement

An alternative means of providing payment details during the entitlement process is provided where retailers, at the point of sale of platforms 109 or later, issue users 118 pre-paid coupons that can be used as entitlements to receive services, and advertisements that are specific to an issuer.

The basic steps are described in FIG. 37. The issuer sells a user a coupon (11-1) that comprises a slip of paper that bears a number or character entitlement sequence covered by an opaque surface. The user removes the opaque surface to reveal and quote the sequence as part of entitlement step (10-9) to the CSR in place of quoting credit card details (11-2). During this step, the CSR verifies that the sequence is valid and takes note of it to prevent its future use. Valid entitlement sequences are a small subset of all possible sequences, so that it is improbable that a fraudulent user may correctly guess a valid, unused sequence without possession of an unused coupon.

Issuers

The entitlement sequence may contain additional information, IssuerIdentity, that identifies the issuer of the coupon. The issuer may choose to sponsor certain content or advertisements and direct these to platforms 109 they have sold. This is useful to issuers, who may be chains of retail stores or loyalty card organisations that represent groups of retail chains, because it allows them to maintain greater contact with users after they left their stores. In a preferred entitlement process, the CSR recovers IssuerIdentity from the entitlement sequence (11-3), stores it for future billing when reconciling payment with the issuer, and includes it in the entitlement message broadcast to the platform (10-14). A platform application 293 recovers IssuerIdentity from the entitlement message and stores it as a non-volatile platform parameter 143 (114). The total population of platforms 109 is consequently divided into sub-populations according to the identity of each of a plurality of issuers.

Advertisements

Each issuer maintains its own database 190 of advertisements, and broadcasts each advertisement via the data centre 100, multiplex operator 106 or the internet 108 to the platforms 109 (11-5). Each advertisement corresponds to a payload 205 within an object 200. A payload expression 204 is associated with each payload 205 and refers to one or more issuer identities, IssuerIdentity, that a platform 109 may have previously downloaded during the entitlement step as platform parameter 143. As already described, the canister loader evaluates expressions 204 during burst events 171 or delta 172 events and downloads a corresponding payloads 205 to the canister 150 where an expression is true (11-6, 11-7, 11-8). In a preferred embodiment, advertisement are panels coded in HTML/Java and stored as files 282 to be displayed by the content browser 287 within the interstitial menu 240 over the notes area 226. However, it can be readily appreciated how an advertisement can be displayed by any other application 293 within any position on the screen using similar steps.

Set-Top-Box Hardware Configuration

FIG. 38 shows the internal functional elements of a typical digital STB 114 designed to receive and decode DVB television transmissions. This is typical of the functionality with which the canister loader interoperates in the consumer television market. This comprises a CPU 303 coupled to volatile DRAM 146 and non-volatile (flash) memory 152. Communication between the CPU and the other blocks is via one or more system data buses 311. The CPU receives user commands from an infra red (IR) handheld control handset 117 via an IR receiver 312. When the STB is in standby, a real time clock (RTC) or countdown timer 308 controls when portions of the STB are to be powered up. In the preferred embodiment, when the STB is in standby mode between downloads, the CPU and memory operate in a low power mode with all other blocks except an RTC 308, IR receiver 312 and programmable power supply 310 powered off completely. The power supply is controlled by the CPU to apply and remove voltage rails to one or more of the other blocks depending on whether the STB is required to enter an active, standby or download state. If the STB has PVR capabilities, there will be some form of bulk storage interface present 304. This would typically be an ATAPI or SCSI hard disk interface, but any popular bulk data storage interface standard may be implemented.

The STB contains a programmable tuner 300, which is connected to receive DVB-T broadcasts via an aerial 116. Additionally, the tuner may be receive cable and satellite transmissions. By means of the internal data bus the canister loader 140 application software can program tuner 300 and de-multiplexer 301 to receive any MPEG2 transport stream (channel) present at aerial 116, including the streams (channel) carrying the data centre's 100 transmissions. The tuned transport stream is applied to a de-multiplexer 301, where elementary audio, video and data streams can be extracted. Video data streams are applied to the MPEG2 video decoder 302. The output of this decoder is then combined with the on screen display OSD to provide the video signal to the television 112. The OSD is responsible for displaying all graphical elements of the canister applications. The video mix and scale function are capable of scaling the decoder video in order to present a reduced size live video display anywhere on television screen 113.

Many of the functional elements described in FIG. 38 may be combined on a single large-scale integration (LSI) silicon component such as STMicroelectronics' STi5517 chipset. In the case of a digital television receiver all the functions described in FIG. 38 are resident within the television chassis. Further the STB may contain a means of data reception from an analogue television signal as a complementary or alternative means to recovery of data from a digital television signal. Data is recovered via an analogue means by decoding data from lines contained within the vertical blanking interval (VBI) of a baseband signal, using a teletext decoder 309, recovered via a programmable tuner 300 from an analogue television channel signal such as encoded according to the PAL, SECAM or NTSC television standards.

A skilled person will appreciate that variations of the disclosed arrangements are possible without departing from the invention. Accordingly the above description of the specific embodiment is made by way of example only and not for the purposes of limitation. It will be clear to the skilled person that minor modifications may be made without significant changes to the operation described.

1. A television system for presenting interactive television services to a user, the system comprising:
a local memory;
means for determining the availability of data from a data source;
means for capturing a first portion of data;
means for storing the first portion in a first area of the local memory, the first portion having a first specified identity;
means for determining whether the first portion references a second portion of the available data depending on a value of one or more parameters stored in the local memory, the second portion having a second specified identity; and
means for capturing the second portion and storing the second portion in a second area of the local memory in the event that a reference between the first and second portions is found, wherein the data captured is usable to provide interactive services for the user.

2. A television system as claimed in claim 1 wherein the local memory includes volatile and non-volatile memory.

3. A system as claimed in claim 2 wherein the first and second memory areas are volatile memory.

4. A system as claimed in claim 2 wherein the volatile memory is in the form of DRAM.

5. A system as claimed in claim 1 wherein the first and/or second areas of memory are provided in a hard drive.

6. A system as claimed in claim 1 further comprising means for processing the first and second portions of data based on steps wholly or partially proscribed in code contained within a downloaded data object, wherein the processed data is stored in the second part of the local memory for use in presenting said interactive services.

7. A system as claimed in claim 1, the system being operable to perform the capturing/downloading of data while the system is not presenting services to a user.

8. A system as claimed in claim 1 wherein the data source is one or more of a broadcast television network and the internet.

9. A system as claimed in claim 1 that is operable to determine whether data that is scheduled to be transmitted from the data source is more recent/up-to-date than the data in the local memory and prevent or omit a scheduled download in the event that data from said source is determined not to be more recent/up-to-date than the data in local memory.

10. A system as claimed in claim 1 wherein one or more portions of the system are powered up immediately prior to receipt of data from the data source and powered down upon receipt of said data.

11. A system as claimed in claim 1 wherein a portion of the data captured from the data source comprises a service entitlement or disentitlement message addressed to the system.

12. A system as claimed in claim 1 wherein the presented interactive service comprises an electronic program guide or an on screen television magazine.

13. A system as claimed in claim 1 wherein the presented interactive service comprises an interactive game.

14. A system as claimed in claim 1 wherein the presented interactive service comprises playback of a stored video or audio clip, or a video or audio stream.

15. A system as claimed in claim 1 comprising a set-top-box or television or video-recorder, cordless or mobile telephone, media jukebox, personal digital assistant, mobile phone or combinations thereof.

16. (canceled)

17. A method for presenting interactive television services to a user of a television system, the method comprising:
determining availability of data from a data source;
capturing at least some of the available data;
storing a first portion of the available data in a first area of a local memory, said first portion having a specified identity;
determining whether the first data portion references a second data portion of the available data depending on a value of one or more parameters stored in the local memory, the second data portion also having a specified identity;
storing the second portion in the first area of local memory in the event that a reference between the first and second portions is found;
processing the first and second portions of data according to their identities;
writing the processed data to a second area of the local memory; and
using the processed data to present interactive television services to the user.

18. A method as claimed in claim 17 wherein said storing steps store data in a local memory that includes volatile and non-volatile memory.

19. A method as claimed in claim 18, wherein said storing steps store data in first and second memory areas that are volatile memory.

20. A method as claimed in claim 18 wherein the volatile memory is DRAM.

21. A method as claimed in claim 17 wherein the step of processing the data is done based on steps wholly or partially proscribed in code contained within a downloaded data object.

22. A method as claimed in claim 17 comprising capturing/downloading data while the system is not presenting services to a user.

23. A method as claimed in claim 17 wherein the data source is a broadcast television network and/or the internet.

24. A method as claimed in claim 17 wherein the television system comprises a set-top-box or television or video-recorder, cordless or mobile telephone, media jukebox, personal digital assistant, mobile phone or combinations thereof.

25. A computer program, preferably on a data carrier or a computer readable medium, for presenting interactive television services to a user of a television system, the computer program having code or instructions for:
determining availability of data from a data source;
capturing the available data;
storing a first portion of the available data in a first area of a local memory, said first portion having a specified identity;
determining whether the first data portion references a second portion of the available data depending on a value of one or more parameters stored in the local memory, the second portion also having a specified identity;
storing the second portion in the first area of local memory in the event that a reference between the first and second portions is found;
processing the first and second portions of data according to their identities;
writing the processed data to a second area of the local memory; and
using the processed data to present interactive television services to the user.

26. A television system comprising:
means for transmitting data streams that include interactive television service content and/or software up-dates; and
a plurality of different user platforms for receiving the data streams,
wherein the data streams include a plurality of different user platform identifiers for identifying which parts of the stream are for use by which platforms, at least some of the data and/or software being sharable by more than one of the platforms, and
wherein at least one of the user platforms is operable to recognize the parts of the data stream that are for use by it and use those parts to cause interactive content or images to be presented on screen simultaneous with or as an alternative to television content.

27. A method for delivering interactive content to a user of a television system comprising:
transmitting broadcasting data streams that include data and/or software for implementing interactive services to a plurality of different user television platforms, wherein the data streams include a plurality of different user platform identifiers for identifying which parts of the stream are for use by which platforms, at least some of the data and/or software being sharable by more than one of the platforms; and
capturing at one or more of the user platforms the parts of the data stream that are for use by it, thereby to cause interactive content or images to be presented on screen simultaneous with or as an alternative to television content.

28. An interactive television system, such as a television, set-top-box or some other consumer electronic appliance that is operable to receive and display a television service, the system having a local memory and being operable to capture/download a conditionally linked data objects; use parameters that are stored in local memory to identify data objects that have to be stored, and in the event that data objects are identified, cause those objects to be stored in local memory.

29. A method for providing interactive television services comprising transmitting/broadcasting a conditional hierarchy of data objects to a plurality of different user platforms, the data objects including parameter identifiers that are usable by the user platforms to identify data objects that are to be stored for later use.

30. A television system as claimed in claim 1 wherein the second data portion is transmitted at a specified/scheduled time of availability and the means for capturing the second data portion are operable to be activated at the time of availability.

31. A television system as claimed in claim 1, wherein the second data portion is transmitted as one or a plurality of conditionally linked data objects, and the system includes means for resolving the identities of the linked objects while one or a plurality of them are captured and stored.

32. A television system as claimed in claim 1 comprising means for detecting the presence and identity of a hardware adapter.

33. A television system as claimed in claim 1 wherein a data object containing executable driver software is downloaded conditionally upon the presence and identity of a hardware adapter.

34. A television system as claimed in claim 32, wherein the hardware adapter is a communications adapter such as local area network adapter.

35. A television system as claimed in claim 34 wherein the communications adapter communicates via wireless means.

36. A television system as claimed in claim 1, wherein the data is transmitted in a platform independent form and the system comprises means for converting that data into a form that can be executed locally.

37. A method as claimed in claim 17 further comprising capturing the second portion at a designated/scheduled time of availability.

38. A method as claimed in claim 17, wherein the second data portion is transmitted as one or a plurality of conditionally linked data objects, and the method involves determining the relevant data within the linked objects after the second portion of data is stored.

39. A method as claimed in claim 17, wherein the data is transmitted in a platform independent form and the method further involves converting data captured into a form that can be executed locally.
